(19) United States
(12) Patent Application Publication
(10) Pub. No.: US 2024/0138402 A1
(43) Pub. Date: May 2, 2024

(54) LIQUID HERBICIDAL COMPOSITIONS

(71) Applicant: BASF SE, Ludwigshafen (DE)

(72) Inventor: Murat Mertoglu, Limburgerhof (DE)

(21) Appl. No.: 18/275,042

(22) PCT Filed: Feb. 4, 2022
(86) PCT No.: PCT/EP2022/052699

§ 371 Date: Jul. 31, 2023

(30) Foreign Application Priority Data
Feb. 5, 2021 (EP) 21155535.4

(51) Int. Cl. A01N 25/22; A01N 25/02; A01N 57/20; A01P 13/00

(52) U.S. Cl. CPC A01N 25/22; A01N 25/02; A01N 57/20; A01P 13/00

(57) ABSTRACT

The present invention relates to a stable aqueous agrochemical composition in form of a liquid herbicidal composition comprising water, a water soluble herbicidal compound and a specific mixture of organic solvents for use in agricultural application methods. The liquid herbicidal composition comprises (A) 5 to 45 weight %, based on the total weight of the composition, of one herbicidal compound selected from glufosinate, a salt thereof, preferably the ammonium salt, and/or its respective (L-)isomers (B) a mixture of two alcoholic solvents, a monohydric alcohol (B.1) and a polyhydric solvents (B.2), wherein (B.1) at least one monohydric alcohol B.1 is selected from methanol, ethanol or isopropanol, or any mixture thereof; and (B.2) at least one polyhydric alcohol B.2 is selected from 1,2-propylene glycol or glycerol, or a mixture thereof; (C) water and (D) 15 to 70 weight %, based on the total weight of the composition, of at least one compound of formula (I) [R-(A)ₓ-OS)₃⁻]-M⁺ (I); wherein R is C₁₀-C₁₆-alkyl, C₁₀-C₁₆-alkenyl, or C₁₀-C₁₆-alkynyl; A is a group wherein R^{A}, R^{B}, R^{C}, and R^{D} are selected from H, CH₃, or CH₂CH₃ with the proviso that the sum of C-atoms of R^{A}, R^{B}, R^{C}, and R^{D} is 0, 1 or 2; M⁺ is a monovalent cation selected from the group of alkali metal ions, NH₄⁺ and an ammonium cation of a primary, secondary or tertiary amine or a quaternary ammonium cation, or a mixture thereof; and x is a number selected from 0 to 10.

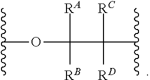

### FIELD OF INVENTION

The present invention relates to a stable aqueous agrochemical composition in form of a liquid herbicidal composition comprising water, a water-soluble pesticide and together with a specific combination of alcoholic components for use in agricultural application methods.

Further objects of the present invention are methods for controlling undesirable vegetation, which method comprise applying the liquid herbicidal composition to a locus where undesirable vegetation is present or is expected to be present; the use of the combined alcoholic components for increasing the stability of the aqueous agrochemical compositions comprising the water-soluble pesticide (or a salt thereof); a method of producing the agrochemical liquid herbicidal composition comprising the step of mixing the alcoholic components with the water soluble herbicide (or a salt thereof) and water; plant propagation material comprising the liquid herbicidal composition; and to a method for treating plant propagation material comprising the step of treating plant propagation material with the liquid herbicidal composition.

### BACKGROUND OF THE INVENTION

Some organic agrochemical active compounds, like herbicides, fungicides, insecticides—or pesticides in general—are often applied in the form of aqueous compositions, especially if they are water-soluble, in order to achieve a good interaction with the target organisms, which can be weeds, fungi or pests like invertebrate pests.

Very often, these aqueous agricultural formulations include in addition to water further solvents, which may increase the biological activity of the herbicide and which may show additional beneficial effects on the physico-chemical properties of the agrochemical composition such as facilitating the load of the components of the composition, meaning higher concentrations of active ingredients and additives.

High concentration formulations are being sought as well for the numerous advantages they offer; for example, less packaging is needed than with low-concentration formulations, corresponding to reductions in the cost and inconveniences of production, transit, and storage. Preparation of spray liquors is also simplified by the smaller quantities of crop protectant that need to be handled.

However, certain drawbacks have been observed in higher concentration formulations. For example, if the biological activity of the active ingredient is dependent on the proportion of active ingredient to a surfactant, but if the amount of surfactant is too high, the viscosity of the composition may become too high for easy handling or spraying.

Product instability such as phase separation has also been a drawback of highly concentrated formulations. Phase separation is undesirable because the concentration of various essential ingredients is no longer uniform throughout the composition.

Especially, the latter phenomenon is a big challenge for formulating agricultural compositions. Because, although such aqueous compositions have a lot of advantages, not only related to the a generally good bioavailability of aqueous composition as discussed above, and also with regard to available water resources, as well as from cost perspectives, they also have some disadvantages.

For instance, in the field of agriculture, farmers need to store their pesticide inventory usually in store houses which generally do not dispose over means for climate and temperature control. Hence, pesticidal compositions which are stored under such variable conditions, needs to be stable over a broad range of climate conditions. Thus, this is especially challenging for aqueous formulations during winter times, as the stored pesticidal compositions may experience quite low temperatures, so that the water content may freeze and may lead to phase separations. One example of a water-soluble herbicidal active ingredient which is challenging to formulate under such aspects is for example glufosinate, which is very often applied in form of its highly water-soluble ammonium salt.

Glufosinate ammonium is a herbicide which is requires high application rates per area for herbicidal control on the one side, but which requires as well the presence of considerable amounts of different adjuvants in the compositions, such as alkylethersulfates, alkylamine ethoxylates (U.S. Pat. No. 10,159,247), alkylsulfosuccinates (WO 2019/007393), (C₈-C₂₀)alkyldimethyl amine N-oxide and an inorganic ammonium salt (US2017/0181434).

Consequently, as there is a need for pesticidal compositions having high concentrations of glufosinate ammonium and the required adjuvants, which facilitate the transport and storage of large quantities of formulated products, the problems mentioned above come into play.

The cold climate storage conditions are therefore quite challenging for glufosinate ammonium formulations because the active ingredient and the adjuvants unfortunately tend to irreversibly phase-separate at colds temperatures.

There have been attempts to address these kinds of problems. WO2007/092351 describes how to prepare glufosinate ammonium compositions, which are stable and do not separate into phases at temperatures as low as −20° C. This effect should be obtained by the use of C₆-C₁₈alkyl polyglycosides, which are supposed to stabilize the composition under cold conditions.

However, the presence of these surfactants also contributes to the concentration of the aqueous composition and “consumes” solubility of the water, which would preferably be used instead for further increasing the content of glufosinate ammonium and adjuvants per liter.

Surprisingly it was now found that the stability of glufosinate ammonium compositions which contain high concentrations of adjuvants and glufosinate ammonium can be achieved at very low temperatures by using specific combinations of alcoholic solvents.

Therefore, the present invention relates to a liquid herbicidal composition comprising water, a water-soluble herbicide, which is glufosinate ammonium, and a combination of monohydric alcohol together with a polyhydric alcohol. In the present invention the monohydric alcohol is selected from methanol, ethanol, isopropanol and/or a mixture thereof, and the polyhydric alcohol is selected from monopropylene glycol, also named as 1,2 propandiol or glycerol or a mixture thereof.

### SUMMARY OF INVENTION

It was found that the specific combination of one or more monohydric alcohols with one or more polyhydric alcohols serves a solvent for stable highly concentrated liquid aqueous agrichemical compositions, which are stable over a broad range of climate conditions, especially at low temperatures.

In particular, it was found that stable liquid herbicidal compositions can be obtained, which comprise water and glufosinate-ammonium as active ingredient and a compound of the formula (I) as described herein, by using the combinations of alcohols according to the present invention. Thus, the combination of certain alcohols as disclosed hereinafter is suitable to load high concentrations of glufosinate-ammonium as active ingredient and a compound of the formula (I) as described herein in aqueous agrochemical compositions.

It is the objective of the present invention to provide herbicidal aqueous compositions, which contain glufosinate-ammonium as active ingredient and a compound of the formula (I) as described herein, that have an enhanced physical and/or chemical stability, and can have high loading with this (and optionally other) agrochemical active ingredient(s) and/or compounds of the formula (I) and at the same can be easily stored, handled and applied by the users, especially the farmers.

This objective is achieved by the solvents mixture according to the present invention, namely a mixture combining monohydric alcohols with polyhydric alcohols, wherein the monohydric alcohols are selected from methanol, ethanol, isopropanol and/or a mixture thereof, and the polyhydric alcohols are selected from monopropylene glycol, also named as 1,2 propandiol or glycerol or a mixture thereof.

### DETAILED DESCRIPTION OF THE INVENTION

The present invention relates to liquid herbicidal compositions comprising as a herbicidal compound at least a derivative of glufosinate, meaning glufosinate itself, a salt thereof, hereby preferably the ammonium salt, and/or the respective (L-)isomer thereof, which liquid herbicidal composition is stable at a broader temperature scale and can therefore also tolerate a high concentration of components. The present invention relates in particular to aqueous liquid herbicidal composition containing
(A) 5 to 45 weight %, based on the total weight of the composition, of one herbicidal compound selected from glufosinate, a salt thereof, preferably the ammonium salt, and/or its respective (L-)isomers
(B) a mixture of two alcoholic solvents, comprising a monohydric alcohol (B.1) and a polyhydric solvent (B.2), wherein
   (B.1) the at least one monohydric alcohol B.1 is selected from methanol, ethanol, n-propanol and isopropanol, and any mixture thereof;
   and
   (B.2) the at least one polyhydric alcohol B.2 is selected from 1,2-propylene glycol and glycerol, and a mixture thereof;
(C) water,
and
(D) 15 to 70 weight %, based on the total weight of the composition, of at least one compound of formula (I)

[R-(A)ₓ-OSO₃⁻]-M⁺ (I);
wherein
R is C₁₀-C₁₆-alkyl, C₁₀-C₁₆-alkenyl, or C₁₀-C₁₆-alkynyl;
A is a group

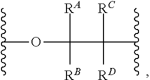

wherein
R^{A}, R^{B}, R^{C}, and R^{D} are selected from H, CH₃, or CH₂CH₃ with the proviso that the sum of C-atoms of R^{A}, R^{B}, R^{C}, and R^{D} is 0, 1 or 2;
M⁺ is a monovalent cation selected from the group of alkali metal ions, NH₄⁺ and an ammonium cation of a primary, secondary or tertiary amine having preferably a molecular weight in the range of 32 to 180 g/mol or a quaternary ammonium cation having preferably a molecular weight in the range of 74 to 180 g/mol, or a mixture thereof; and
x is a number selected from 0 to 10.

The aqueous liquid herbicidal compositions according to the present invention are stable transparent or translucent, visually apparent single-phase solutions when stored at temperatures between 0° C. and 50° C. The stability of the aqueous compositions can easily be evaluated visually when no phase separation and no substantial change in the light transmittance is to be observed, whereas instable aqueous liquid herbicidal composition would become turbid and/or would separate in an at least two phases either immediately during the preparation of compositions or over time during storage.

Moreover, the stability of highly loaded liquid herbicidal compositions (meaning having a high concentration of active ingredients and adjuvants) is dependent on temperature. They can be prepared without strong agitation at a given temperature, but they can also immediately separate in phases if the system becomes instable due temperature change. A highly loaded aqueous solation, which is stable at 25° C., may therefore not be stable at other temperatures. Different temperatures over the storage time may cause that the solution may become turbid and phase-separation is observed.

Thus, considering the usage and storage of pesticides mixture formulations under real agricultural conditions and applications, it is not sufficient to develop a pesticide composition, which is stable only at room temperature. Pesticidal formulations are in general applied between 0° C. and 50° C. depending on the climate condition. Therefore, a liquid herbicidal composition for pesticidal use must be stable at a larger temperature range. The liquid herbicidal composition of the present invention comprising the inventive solvent combination described herein is particularly suitable for this purpose. Products comprising such combination are shown to be stable in a range between 0° C. and 50° C.

Therefore, as an essential component the liquid herbicidal composition of the present invention contains as active ingredient at least one herbicidal compound selected from glufosinate, a salt thereof, preferably the ammonium salt, and/or its respective (L-)isomers.

As further essential components the liquid herbicidal composition of the present invention contains as solvents a mixture of two certain types of alcoholic solvents, which is a monohydric alcohol (B.1) and a polyhydric solvents (B.2), wherein at least one monohydric alcohol (B.1) is selected from methanol, ethanol or isopropanol, or any mixture thereof; and (B.2) at least one polyhydric alcohol B.2 is selected from 1,2-propylene glycol or glycerol, or a mixture thereof.

A further essential component of the liquid herbicidal composition is the compound of the formula (I) as described herein.

If not stated otherwise, the amounts of the components of the liquid herbicidal composition given in weight % refer to the total weight of the liquid herbicidal composition. If not stated otherwise, the terms “weight %” and “% by weight” are used synonymously.

### Components of the Liquid Herbicidal and Preparation Methods

In general, terms mentioned in their plural form refer to a situation wherein only the singular term applies as well unless specifically expressed otherwise.

As mentioned above, the water-soluble herbicidal active (A) to be used in the liquid herbicidal composition according to the present invention is glufonsinate, especially a water soluble glufosinate salt. In particular, glufosinate, especially a water soluble salt thereof, is the sole herbicide compound contained in the composition of the invention.

Glufosinate (CAS Reg. No. 51276-47-2), with IUPAC-Name (2RS)-2-amino-4-[hydroxy(methyl)phosphinoyl]butyric acid, or 4-[hydroxy(methyl)phosphinoyl]-DL-homoalanine) or DL-4-[hydroxyl(methyl)phosphinoyl]-DL-homoalaninate, is known, as well as agronomically acceptable salts thereof, in particular glufosinate-ammonium (IUPAC-Name: ammonium (2RS)-2-amino-4-(methylphosphinato)butyric acid, CAS Reg. No. 77182-82-2). U.S. Pat. No. 4,168,963 describes phosphorus-containing compounds with herbicidal activity, of which, in particular, phosphinothricin (2-amino-4-[hydroxy(methyl)phosphinoyl]butanoic acid; common name: glufosinate) and its salts have acquired commercial importance in the agrochemistry (agricultural chemistry) sector.

For example, glufosinate and its salts—such as glufosinate ammonium—and its herbicidal activity have been described e.g. by F. Schwerdtle et al. Z. Pflanzenkr. Pflanzenschutz, 1981, Sonderheft IX, pp. 431-440.

Glufosinate as racemate and its salts are commercially available under the trade-names Basta™ and Liberty™.

Glufosinate is represented by the following structure (IV):

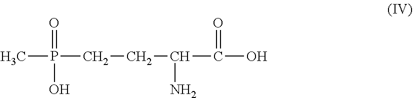

The compound of formula (IV) is a racemate.

Glufosinate is a racemate of two enantiomers, out of which only one shows sufficient herbicidal activity (see e.g. U.S. Pat. No. 4,265,654 and JP92448/83). Even though various methods to prepare L-glufosinate (and respective salts) are known, the mixtures known in the art do not point at the stereochemistry, meaning that the racemate is present (e.g. WO 2003024221, WO2011104213, WO 2016113334, WO 2009141367).

In one embodiment, the herbicidal composition comprises racemic glufosinate mixtures as described above, wherein the glufosinate comprises about 50% by weight of the L-enantiomer and about 50% by weight of the D-enantiomer. In another embodiment, the herbicidal composition comprises glufosinate, wherein at least 70% by weight of the glufosinate is L-glufosinate or a salt thereof. Here, % by weight refers to the total weight of glufosinate present in the liquid herbicidal composition.

L-glufosinate, with IUPAC-Name (2S)-2-amino-4-[hydroxy(methyl)phosphinoyl]butyric acid (CAS Reg. No. 35597-44-5) and also called glufosinate-P, can be obtained commercially or may be pre-pared for example as described in WO2006/104120, U.S. Pat. No. 5,530,142, EP0248357A2, EP0249188A2, EP0344683A2, EP0367145A2, EP0477902A2, EP0127429 and J. Chem. Soc. Perkin Trans. 1, 1992, 1525-1529.

Preferably, the salts of glufosinate or (L)-glufosinate are the sodium, potassium or ammonium (NH₄⁺) salts of glufosinate or L-glufosinate, in particular glufosinate-P-ammonium (IUPAC-Name: ammonium (2S)-2-amino-4-(methylphosphinato)butyric acid, CAS Reg. No. 73777-50-1), glufosinate-P-sodium (IUPAC-Name: sodium (2S)-2-amino-4-(methylphosphinato)butyric acid; CAS Reg. No. 70033-13-5) and glufosinate-P-potassium (IUPAC-Name: potassium (2S)-2-amino-4-(methylphosphinato)butyric acid) for L-glufosinate.

Hence, mixtures according to the herbicidal composition may contain (L)-glufosinate-ammonium or (L)-glufosinate-sodium or (L)-glufosinate-potassium as (L)-glufosinate salts and (L)-glufosinate as free acid, preferably (L)-glufosinate. Especially preferred are herbicidal compositions, which contain (L)-glufosinate-ammonium, i.e. the ammonium (NH₄⁺) salt of glufosinate.

The term “glufosinate” as used in the present invention typically comprises, in one embodiment of the invention, about 50% by weight of the L-enantiomer and about 50% by weight of the D-enantiomer; and in another embodiment of the invention, more than 70% by weight of the L-enantiomer; preferably more than 80% by weight of the L-enantiomer; more preferably more than 90% of the L-enantiomer, most preferably more than 95% of the L-enantiomer and can be prepared as referred to above.

The monohydric and polyhydric alcohols B.1 and B.2, respectively, contained in the composition of the present invention as organic solvents as a specific mixture. The monohydric alcohol is selected from C₁-C₃-alcohols, such as CH₃OH, CH₃CH₂OH, CH₃CH₂CH₂OH and CH₃CH(OH)CH₃ and any mixture thereof. Alcohols on the polyhydric side B.2. are selected from 1,2-propanediol, also termed 1,2-propylene glycol, and glycerol and mixtures thereof.

Here and in the following the monohydric alcohols B.1 are also termed solvent B.1. Similarly, the polyhydric alcohols B.2 are also termed solvent B.2.

Preferably, the monohydric alcohol B.1 comprises ethanol and may be a mixture of ethanol with methanol or isopropanol. The particularly preferred monohydric alcohol B.1 is ethanol. The preferred polyhydric alcohol B.2 is 1,2-propandiol.

The liquid herbicidal composition typically contains 1 to 20 weight %, in particular 2 to 15 weight 40%, especially 2 to 10 weight %, based on the total weight of the liquid composition, of the solvent B.1. The liquid herbicidal composition typically contains 1 to 30 weight %, in particular 2 to 20 weight %, especially 2 to 15 weight %, based on the total weight of the liquid composition, of the solvent B.2.

The aqueous liquid herbicidal composition according to the present invention, wherein the composition can be prepared by the following method comprising the steps of
(a) providing a solvent B.1 as defined herein above,
(b) providing a solvent B.2 as defined herein above,
(c) combining the two solvent components B.1 and B.2 to a mixture,
(d) combining obtained mixture of the solvent components with water and the herbicidal compound A as defined herein above and the compound of the formula (I) as defined hereinabove.

In step (d) water and the herbicide compound A may be combined with the solvent mixture of B.1 and B.2 as such or as an aqueous solution of the herbicidal compound A.

The liquid herbicidal composition according to the present invention additionally comprises a compound of formula (I):

[R-(A)ₓ-OSO₃⁻]-M⁺ (I);
wherein
the variables R, A, x and M+ are as defined herein.

In formula (I)
M⁺ is a monovalent cation which is in particular selected from the group of alkali metal ions, NH₄⁺ and an ammonium cation of a primary, secondary or tertiary amine having a molecular weight of from 32 to 180 g/mol, or a mixture thereof; and
x is a number which is either 0 or selected from 1 to 10.

These compounds of formula (I) can be prepared by standard methods of organic chemistry. The respective anionic moiety R-(A)ₓ-OSO₂⁻ (I-a) is commercially available in the form of sodium or potassium salts, e.g. under the tradename Genapol LRO from Clariant, and can be prepared as described in US10091994B2, columns 1-2, which is incorporated herein by reference. Compounds of formula (I) are ionic compounds that comprise the anionic moiety (I-a) and the mono-valent cation M⁺, which is positively and singly charged.

The compounds of formula (I) may contain an alkali metal ion, such as sodium or potassium as the monovalent cation M⁺, or an ammonium cation, such as NH₄⁺, or a primary, secondary, or tertiary amine, i.e. a protonated primary, secondary or tertiary amine, or a quaternary ammonium cation.

The term “ammonium” per se refers to the cation NH₄⁺. The expression “ammonium cations of primary, secondary or tertiary amines”, as used similarly in the expression “primary, secondary, tertiary amines, and ammonium salts thereof” refers to protonated primary, secondary or tertiary amines. The protonation of such ammonium cations is dependent on the pH and the positive charge varies accordingly.

The molecular weight of the protonated primary, secondary or tertiary amine and the a quaternary ammonium cation is typically in the range of 32 to 180 g/mol. Preferably, the primary, secondary or tertiary amine and the a quaternary ammonium cation have exactly 1 nitrogen atom, i.e. it bears a single positive charge.

Such compounds are available from the commercially available sodium or potassium salts by ion exchange chromatography or other methods suitable for ion exchange. Alternatively, compounds of formula (I), wherein M⁺ is NH₄⁺ or an ammonium cation of a primary, secondary, or tertiary amine, are available by reaction of compounds of formula (I) with SO₃ or ClSO₃H and subsequent addition of the respective amine base or ammonia M as depicted in Scheme 1

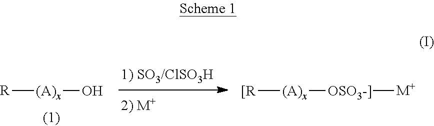

wherein all variables have a meaning as defined for formula (I).

Reactions of this type are typically carried out at temperatures of 50 to 100° C. under addition of an excess of SO₃ or ClSO₃H compared to the amount of compound of formula (I), compound of formula (II) respectively. Compounds of formula (1) and (1a) are commercially available under various tradenames, e.g. the Lutensol TO series from BASF, and may be produced from the respective alcohols R—OH by alkoxylation with ethylene oxide, propylene oxide, or butylene oxide as described in US10091994B2.

### EMBODIMENTS AND PREFERENCES OF THE INVENTION

The individual embodiments of the present inventions are given herein below. They intend to further illustrate the invention, and the preferences listed within do not impose any limitations whatsoever to the interpretation thereof.

According to the invention, the liquid herbicidal composition comprises 5 to 45 weight % of the herbicidal compound A.

In particular, the liquid herbicidal composition according to the present invention comprises preferably 10 to 40 weight % of the herbicidal compound A.

The liquid herbicidal composition according to the present invention, wherein the composition comprises more preferably 13 to 36 weight % of the herbicidal compound A.

In a preferred group of embodiments the herbicidal compound A to be formulated in the liquid herbicidal composition of the present invention is a glufosinate salt.

In particular the glufosinate salt is glufosinate ammonium.

In a preferred embodiment the herbicidal compound A to be formulated in the liquid herbicidal composition of the present invention is a L-enantiomer of glufosinate.

In particular the L-glufosinate salt is L-glufosinate-ammonium.

Frequently, the liquid herbicidal composition according to the present invention comprises 1 to 20 weight % of solvent B.1.

The liquid herbicidal composition according to the present invention preferably comprises 2 to 15 weight% of solvent B.1.

More preferably, the liquid herbicidal composition according to the present invention, comprises 2 to 10 weight % of solvent B.1.

Preferably the liquid herbicidal composition according to the present invention comprises as monohydric solvent B.1 ethanol.

Frequently, the liquid herbicidal composition according to the present invention comprises 1 to 30 weight % of solvent B.2,

The liquid herbicidal composition according to the present invention preferably comprises 2 to 20 weight % of solvent B.2.

More preferably, the liquid herbicidal composition according to the present invention, composition comprises more preferably 2 to 15 weight % of solvent B.2.

Preferably the liquid herbicidal composition according to the present invention comprises as polyhydric solvent B.2 1,2-propandiol.

The total amount of the solvents B.1 and B.2 is typically in the range of 3 to 40 weight %, in particular in the range of 4 to 30 weight % or 4 to 25 weight %, based on the total weight of the liquid composition.

The liquid herbicidal composition typically may also contain one or more further mono- or polyhydric alcohols B.3, which are different from the alcohols B.1 and B.2. In particular, the further alcohol is selected from poly-C₂-C₃-alkylene glycols, poly-C₂-C₃-alkylene glycol monomethyl ether and C₂-C₃-alkylene glycol monomethyl ethers. Examples of solvents B.3 include ethylene glycol monomethyl ether, propylene glycol monomethyl ether, diethylene glycol, dipropylene glycol, tripropylene glycol, diethylene glycol monomethyl ether, dipropyleneglycol monomethyl ether and polyethylene glycol. The molecular weight (number average as determined by mass spectrometry) of such a polyethylene glycol is typically in the range of 106 to 500 g/mol. Preference is given to dipropylene glycol as solvent B.3.

If present, the liquid herbicidal composition typically contains the alcohol B.3 in an amount in the range of 3 to 35 weight %, in particular in the range of 4 to 30 weight %, especially in the range of 5 to 25 weight %, based on the total weight of the liquid composition.

If the solvent B.3 is present in the liquid herbicidal composition, the total amount of the solvents B.1, B.2 and B.3 is typically in the range of 6 to 50 weight %, in particular in the range of 8 to 40 weight % or 10 to 35 weight %, based on the total weight of the liquid composition.

In addition to the aforementioned components A, B.1, B.2 optionally B.3 and D, the liquid herbicidal composition of the invention contains water. The amount of water will generally be at least 5 weight %, in particular at least 7 weight % and especially at least 8 weight %, based on the total weight of the liquid composition. The amount of water may generally not exceed 78 weight % and is preferably not higher than 65 weight % or 50 weight %, and especially not higher than 40 weight % or 36 weight %, based on the total weight of the liquid herbicide composition. In particular, the liquid herbicidal composition of the invention contains water in an amount of 5 to 50 weight %, more particularly in an amount of 7 to 50 weight % or 7 to 40 weight % and especially in an amount in the range of 8 to 40 weight % or 8 to 36 weight %, based on the total weight of the liquid herbicide composition.

In a particular group 1 of embodiments, the liquid herbicidal composition according to the present invention comprises
A) 10 to 40 weight % of the herbicidal compound A, which is preferably glufosinate ammonium;
B.1) 2 to 15 weight % of ethanol;
B.2) 2 to 20 weight % of 1,2-propanediol;
C) at least 7 weight %, e.g. 7 to 50 weight %, of water; and
D) 15 to 70 weight % of at least one compound of the formula (I) as defined herein.

In a particular subgroup 1a of group 1 of embodiments, the liquid herbicidal composition according to the present invention comprises
A) 13 to 36% weight % of the herbicidal compound A, which is preferably glufosinate ammonium;
B.1) 2 to 10 weight % of ethanol;
B.2) 2 to 15 weight % of 1,2-propanediol;
C) at least 8 weight %, e.g. 8 to 36 weight %, of water; and
D) 15 to 70 weight % of at least one compound of the formula (I) as defined herein.

In a particular group 2 of embodiments, the liquid herbicidal composition according to the present invention comprises
A) 10 to 40 weight % of the herbicidal compound A, which is preferably glufosinate ammonium;
B.1) 2 to 15 weight % ethanol;
B.2) 2 to 20 weight % of 1,2-propanediol;
B.3) 5 to 30 weight % of dipropylene glycol;
C) at least 7 weight %, e.g. 7 to 50 weight %, of water; and
D) 15 to 70 weight % of at least one compound of the formula (I) as defined herein.

In a particular subgroup 2a of the group 2 of embodiments, the liquid herbicidal composition according to the present invention comprises
A) 13 to 36% weight % of the herbicidal compound A, which is preferably glufosinate ammonium;
B.1) 2 to 10 weight % of ethanol;
B.2) 2 to 15 weight % of 1,2-propanediol;
B.3) 5 to 30 weight % of dipropylene glycol;
C) at least 8 weight %, e.g. 8 to 36 weight % of water; and
D) 15 to 70 weight % of at least one compound of the formula (I) as defined herein.

The liquid herbicidal composition according to the present invention comprises 15 to 70 weight % of a compound of formula [R-(A)ₓ-OSO₃⁻]-M⁺ (I) as defined herein above. The following disclosure of preferred groups 3, 4, 5 and 6 of embodiments of the compound of formula (I) apply either alone or in combination to all groups of embodiments disclosed herein and in particular apply to groups 1, 1a, 2 and 2a of embodiments.

According to a group 3 of embodiments, the liquid herbicidal compositions of the invention contain a compound of formula (I) wherein the index x is 0.

According to another group 4 of embodiments, the liquid herbicidal compositions contain a compound of formula (I) wherein the index x is from 1 to 10. In this particular group 4 of embodiments, preference is given the liquid herbicidal compositions which contain a compound of formula (I) wherein the index x is from 1 to 3.

Amongst the aforementioned compositions of the group 4 of embodiments, preference is given to compounds of formula (I) wherein R^{A}, R^{B}, R^{C}, and R^{D} are each H.

According to a group 5 of embodiments, preference is given to compositions of the invention, in particular to compositions according to the groups 1, 1a, 2, 2a, 3 and 4 of embodiments, wherein in compound of formula (I), the cation M⁺ is a protonated primary, secondary, or tertiary amine, or a quaternary ammonium cation, where the protonated primary, secondary, or tertiary amine, or a quaternary ammonium cation contains exactly one nitrogen atom per molecule.

Amongst the compositions of the group 5 of embodiments, preference is given to liquid herbicidal composition according to the present invention, wherein in compound of formula (I), the cation M⁺ is of formula (II)

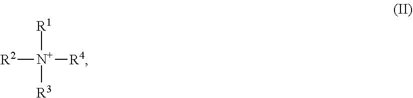

wherein
R¹, R², R³ and R⁴ are H or C₁-C₁₀-alkyl, which is unsubstituted or substituted with OH, C₁-C₁₀-alkoxy, or hydroxy-C₁-C₁₀-alkoxy; or
   two of the substituents R¹, R², R³, and R⁴ form, together with the N-atom to which they are bound, a 5-, or 6-membered, saturated, partially- or fully unsaturated heterocycle containing optionally and additionally one or two oxygen or sulfur atoms, wherein said sulfur atom(s) are independently from one another oxidized or non-oxidized.

Amongst the compositions of the group 5 of embodiments, preference is given to the liquid herbicidal composition according to the present invention, wherein in compound of formula (I) the cation M⁺ is a protonated amine selected from ethanolamine, diethanolamine, diglycolamine, 1-aminopropan-2-ol, 2-dimethylaminoethanol, 2-(butylamino)ethanol, 2-diethylaminoethanol, 2-(tert-butylamino)ethanol, N-(tert-butyl)diethanolamine, triethanolamine, 2-ethylaminoethanol, 2-aminoheptan, triisopropylamine, N-(2-hydroxyethyl)morpholin, N-methylmorpholine, N-butyldiethanolamin or 2-(dibutylamino)ethanol, or any mixture thereof.

Amongst the compositions of the group 5 of embodiments, particular preference is given to the liquid herbicidal composition according to the present invention, wherein in compound of formula (I) the cation M⁺ is preferably a protonated amine selected from ethanolamine, diethanolamine, diglycolamine, 1-aminopropan-2-ol, 2-dimethylaminoethanol or triethanolamine, or any mixture thereof.

According to another preferred group 6 of embodiments, the liquid herbicidal composition according to the present invention the cation M⁺ in the compound of formula (I) is an alkalimetal cation, in particular sodium. The statement made with regard to the other groups of embodiments, except for the group 5, apply in the same way for the group 6 of embodiments. In particular, the statements made with regard to groups 1, 1a, 2, 2a, 3 and 4 of embodiments.

The liquid herbicidal compositions of the present invention may further contain one or more alkyl polyglucosides, also termed APGs. APGs may further increase the stability of the formulation against phase separation at low temperatures. APGs can be described by the following formula (III)

R^{a}O(R^{b}O)_{b}(Z)ₐ (III)

where
R^{a} is a monovalent hydrocarbon radical, in particular an alkyl or alkenyl radical, having from 6 to 30 carbon atoms, in particular 8 to 16 carbon atoms;
R^{b} is a divalent alkylene radical having from 2 to 4 carbon atoms, in particular ethandiyl;
Z3 is a glucose residue;
b is a number ranging from 0 to 12 and which is in particular 0 or 1 to 4; and
a is a number ranging from 1 to 6, in particular ranging from 1.1 to 2 and represents the average degree of polymerization of the glucoside units.

Non-limiting examples of commercially available alkyl polyglucosides include, for example, APG®, AGNIQUE® and AGRIMUL® surfactants from BASF; Atlox surfactants from Uniqema; or AG surfactants from AKZO NOBEL Surface Chemistry, LLC, such as:
1. AGNIQUE PG 8105 Surfactant: An alkyl polyglucoside having an average degree of polymerization of 1.5, wherein the group R^{a} is alkyl and contains 8 to 10 carbon atoms.
2. AGNIQUE PG 8166 Surfactant: An alkyl polyglucoside having an average degree of polymerization of 1.6, wherein the group R^{a} is alkyl and contains 8 to 16 carbon atoms.
3. AGNIQUE PG 266 Surfactant: An alkyl polyglucoside having an average degree of polymerization of 1.6, wherein the group R^{a} is alkyl and contains 12 to 16 carbon atoms.
4. AGNIQUE PG 9116 Surfactant: An alkyl polyglucoside having an average degree of polymerization of 1.6, wherein the group R^{a} is alkyl and contains 9 to 11 carbon atoms.
5. AGNIQUE PG 264-U Surfactant: An alkyl polyglucoside having an average degree of polymerization of 1.4, wherein the group R^{a} is alkyl and contains 12 to 16 carbon atoms.
6. AGNIQUE PG 8107 Surfactant: An alkyl polyglucoside having an average degree of polymerization of 1.7, wherein the group R^{a} is alkyl and contains 8 to 16 carbon atoms.
7. AGNIQUE PG 266 Surfactant: An alkyl polyglucoside having an average degree of polymerization of 1.6, wherein the group R^{a} is alkyl and contains 12 to 16 carbon atoms.
8. AL 2575/AL 535 Surfactant: An alkyl polyglucoside having a HLB of 12-13, wherein the group R^{a} is alkyl and contains 12 to 13 carbon atoms.
9. Akzo Nobel AG 6202, AG 6206, or AG 6210 surfactants: Alkyl polyglucosides wherein the group R^{a} is branched C₈ alkyl, linear hexyl and linear C₈-C₁₀ alkyl, respectively.

The liquid herbicidal compositions according to the present invention may further comprise up to 20 weight % of other ingredients, which are different from the aforementioned components A, B.1, B.2, B.3, C, D and E, which are typically selected from further solvents, pigments, antifoaming agents, anionic, nonionic, cationic or zwitterionic surfactants as thickeners.

Preferably, the liquid herbicidal composition comprises an agrochemically effective amount of the glufosinate or salt thereof. The term “effective amount” denotes an amount of an agrochemically active ingredient or composition, which is sufficient to achieve a biological effect, such as controlling harmful weeds on cultivated plants or in the protection of materials and which does not result in a substantial damage to the treated plants. Such an amount can vary in a broad range and is dependent on various factors, such as the pest species to be controlled, the treated cultivated plant or material, the climatic conditions and the specific agrochemical active ingredient used.

The liquid herbicidal composition comprises the glufosinate, or a salt thereof, in a concentration of at least 5 wt % preferably at least 10 wt %, most preferably at least 15 wt %, in particular at least 20 wt %, and especially at least 25 wt %, such as at least 30 wt % based on the total weight of the herbicidal composition. The liquid herbicidal agrochemical composition may comprise the glufosinate, or a salt thereof, in a concentration of up to 50 wt %, preferably up to 40 wt %, more preferably up to 30 wt % based on the total weight of the herbicidal composition. The herbicidal composition may comprise the glufosinate, or a salt thereof, in a concentration of from 5 to 50 wt %, preferably 5 to 40 wt %, more preferably 10 to 30 wt %.

Although glufosinate and/or its salts would be the preferred water-soluble agrochemical active, as mentioned above, also other water-soluble herbicides could be used in the liquid herbicidal composition compositions according the present invention.

The liquid herbicidal composition according to the present invention is especially suitable for formulating as well water-insoluble or sparingly water soluble pesticide in agrochemical compositions. Such water insoluble pesticidal actives can be selected from the group of fungicides, insecticides and herbicides.

According to the invention, the aqueous agrochemical composition comprises water. Typically, the liquid herbicidal composition comprises water in a concentration of at least at least 5 wt, more preferably at least 7 wt % or at least 8 wt % or at least 10 wt %, most preferably at least 15 wt %. The agrochemical composition may comprise water in a concentration of up to 50 wt %, preferably up to 40 wt %, more preferably up to 30 wt %, and in particular up to 25 wt %. The agrochemical composition typically comprises water in a concentration in the range of 5 to 50 wt %, preferably in the range of 7 to 50 wt % or 7 to 40 wt % and especially in the range of 8 to 4 wt % or 8 to 36 wt %. If the concentration of water in the agrochemical composition is at least 5 wt %, such compositions may be referred to as aqueous compositions.

The herbicidal composition may also comprise further organic solvents, which are different from the solvents B.1, B.2 and B.3. Suitable organic solvents are defined herein below. In particular, such further solvents are absent or virtually absent, i.e. their concentration is lower than 0.5 weight %. Preferred are such organic solvents that have a water-solubility of at least 1 wt % at 20° C., preferably at least 10 wt % at 20° C. Typically, the amount of further solvents will not exceed 5 weight %, based on the total weight of the herbicidal composition and is typically lower than 2 weight %.

Suitable further organic solvents are esters, preferably esters of aliphatic C₁-C₆-alcohols with aliphatic C₁-C₆-carboxylic acids, esters of aromatic C₆-C₁₀-alcohols with aromatic C₆-C₁₀-carboxylic acids, cyclic esters of ω-hydroxy-C₁-C₆-carboxylic acids, such as CH₃C(O)OCH₂CH₃, CH₃C(O)OCH₃, CH₃C(O)OCH₂CH₂CH₂CH₃, CH₃C(O)OCH(CH₃)CH₂CH₃, CH₃C(O)OC(CH₃), CH₃CH₂CH₂C(O)OCH₂CH₃, CH₃CH(OH)C(O)OCH₂CH₃, CH₃CH(OH)C(O)OCH₃, CH₃C(O)OCH₂CH(CH₃)₂, CH₃C(O)OCH(CH₃)₂, CH₃CH₂C(O)OCH₃, benzyl benzoate, acetophenone, γ-valerolactone and γ-butyrolactone; carbonates, such as ethylene carbonate, propylene carbonate, butylene carbonate, CH₃CH₂OC(O)OCH₂CH₃, and CH₃OC(O)OCH₃; dimethylacetamide, dimethylcaprylamide, dimethylcapramide, and N-alkylpyrrolidones; esters based on glyceryl and carboxylic acids, such as glyceryl mono-, di and triacetate, phthalic esters, ethyl lactate, 2-ethylhexyl, D- or L-(2-ethylhexyl) lactate; amides and urea derivatives, such as dimethyl acetamide (DMA), 1,3-dimethyl-2-imidazolidinone (DMI), 1,3-dimethyl-3,4,5,6-tetrahydro-2(1H)-pyrimidinone (DMPU), hexamethylphosphamide (HMPA); moreover dimethyl sulfoxide (DMSO), tetrahydrofurfuryl alcohol and sulfolane. Preferred further solvents are butanol, n-, iso, tert- and 2-butanol, ethylene glycol, γ-valerolactone and γ-butyrolactone and tetrahydrofurfuryl alcohol.

The herbicidal compositions are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005.

The herbicidal composition may typically comprise further auxiliaries. Suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable adjuvants are compounds, which have a neglectable or even no pesticidal activity themselves, and which improve the biological performance of the compound I on the target. Examples are surfactants, mineral or vegetable oils, and other auxilaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), anorganic clays (organically modified or unmodified), polycarboxylates, and silicates. Suitable bactericides are bronopol and isothiazolinone derivatives such as alkylisothiazolinones and benzisothiazolinones. Suitable anti-freezing agents are ethylene glycol, propylene glycol, urea and glycerin.

Suitable anti-foaming agents are silicones, long chain alcohols, and salts of fatty acids. Particularly preferred are silicone-based anti-foaming agents such as polydimethylsiloxanes (e.g. SAG 1572 as available from Momentive, Silcolapse-481 or Silcolapse-482 from Elkem). Suitable silicone-based anti-foaming agents have also been described in WO2005/117590A2,

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants). Suitable tackifiers or binders are polyvinylpyrrolidons, polyvinylacetates, polyvinyl alcohols, polyacrylates, biological or synthetic waxes, and cellulose ethers.

Various types of oils, wetters, adjuvants, fertilizer, or micronutrients, and further pesticides (e.g. herbicides, insecticides, fungicides, growth regulators, safeners) may be added to the herbicidal composition comprising them as premix or, if appropriate not until immediately prior to use (tank mix). These agents can be admixed with the agrochemical compositions according to the invention in a weight ratio of 1:100 to 100:1, preferably 1:10 to 10:1.

The user applies the agrochemical liquid herbicidal composition composition according to the invention usually from a predosage device, a knapsack sprayer, a spray tank, a spray plane, or an irrigation system. Usually, the herbicidal composition is made up with water, buffer, and/or further auxiliaries to the desired application concentration and the ready-to-use spray liquor or the herbicidal composition according to the invention is thus obtained. Usually, 20 to 2000 liters, preferably 50 to 400 liters, of the ready-to-use spray liquor are applied per hectare of agricultural useful area.

According to one embodiment, individual components of the agrochemical composition according to the invention such as parts of a kit or parts of a binary or ternary mixture may be mixed by the user himself in a spray tank and further auxiliaries may be added, if appropriate.

In a further embodiment, either individual components of the agrochemical composition according to the invention or partially premixed components, e. g. components comprising compounds of formula (I) and (II) and/or the water soluble pesticide or a salt thereof and/or the water insoluble pesticide may be mixed by the user in a spray tank and further auxiliaries and additives may be added, if appropriate.

In a further embodiment, either individual components of the herbicidal composition according to the invention or partially premixed components can be applied jointly (e.g. after tank mix) or consecutively.

The agrochemical compositions according to the present invention have a comparatively low dynamic viscosity and stay homogeneous even at high concentrations of pesticidal active compounds.

The dynamic viscosity as referred to herein can be measured by means of a Brookfield viscosimeter, i.e. a rotational viscosimeter with a cone-plate geometry. The dynamic viscosity may be determined according to industry standard EN ISO_{2555:2018}. Usually, the dynamic viscosity is measured at 25° C. In this method, the shear rate of the rotation viscosimeter is constantly increased and the shear stress is measured. For Newtonian Fluids, the measurement results in a linear dataset according to a direct proportionality between the shear stress and the shear rate. For non-Newtonian fluids, the measurement results in a non-linear dependency between shear stress and shear rate. The dynamic viscosity, also called apparent viscosity, is typically determined by measuring the slope of a line through the origin of the coordinate system and the shear stress as determined at a shear rate of 100/second. The true viscosity, which may be different from the apparent viscosity for non-Newtonian fluids, is determined by calculating the slope of the tangent of the experimental curve as measured at a shear rate of 100/second.

The agrochemical composition of the invention usually has a true viscosity at 20° C. of less than to 2000 mPas, preferably less than 1000 mPas, more preferably less than 500 mPas. The agrochemical composition usually has an apparent viscosity at 20° C. of less than to 3000 mPas, preferably less than 1500 mPas, more preferably less than 1000 mPas.

### Embodiments of Herbicidal Application Methods

The present invention relates as well to the use of the liquid herbicidal composition as defined herein above in the field of agriculture.

Depending on the application method in question, the agrochemical liquid herbicidal compositions according to the present invention can be employed for eliminating undesirable pests in crops, such as weeds.

Hence, the aqueous agrochemical composition of the present invention is preferably used to prepare liquid herbicidal compositions for eliminating weeds in crop plants. Therefore, the liquid herbicidal composition according to the present invention, is used in methods for controlling undesired plant growth and/or controlling harmful plants by being applied onto the undesired plants or the harmful plants, on parts of the undesired plants or the harmful plants, or on the area where the undesired plants or the harmful plants grow.

Accordingly, these herbicidal compositions control vegetation on non-crop areas very efficiently, especially at high rates of application. They act against broad-leafed weeds and grass weeds in crops such as wheat, rice, corn, soybeans and cotton without causing any significant damage to the crop plants. This effect is mainly observed at low rates of application.

Such herbicidal compositions according to the invention are applied to the plants mainly by spraying the leaves. Here, the application can be carried out using, for example, water as carrier by customary spraying techniques using spray liquor amounts of from about 100 to 1000 l/ha (for example from 300 to 400 l/ha). The herbicidal compositions may also be applied by the low-volume or the ultra-low-volume method, or in the form of microgranules.

Application of the herbicidal compositions according to the present invention can be done before, during and/or after, preferably during and/or after, the emergence of the undesirable plants.

When employed in plant protection, the amounts of glufosinate or salt thereof without formulation auxiliaries, are, depending on the kind of effect desired, from 0.001 to 2 kg per ha, preferably from 0.005 to 2 kg per ha, more preferably from 0.05 to 0.9 kg per ha and in particular from 0.1 to 0.75 kg per ha.

When used in the protection of materials or stored products, the amount of glufosinate or salt thereof applied depends on the kind of application area and on the desired effect. Amounts customarily applied in the protection of materials are 0.001 g to 2 kg, preferably 0.005 g to 1 kg, of agrochemical active ingredient per cubic meter of treated material.

Examples of suitable crops are the following:
Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera, Zea mays.

The herbicidal compositions according to the invention can also be used in crops which have been modified by mutagenesis or genetic engineering in order to provide a new trait to a plant or to modify an already present trait, preferably a resistance against glufosinate or its salts.

The term “crops” as used herein includes also (crop) plants which have been modified by mutagenesis or genetic engineering in order to provide a new trait to a plant or to modify an already present trait.

Mutagenesis includes techniques of random mutagenesis using X-rays or mutagenic chemicals, but also techniques of targeted mutagenesis, in order to create mutations at a specific locus of a plant genome. Targeted mutagenesis techniques frequently use oligonucleotides or proteins like CRISPR/Cas, zinc-finger nucleases, TALENs or meganucleases to achieve the targeting effect.

Genetic engineering usually uses recombinant DNA techniques to create modifications in a plant genome which under natural circumstances cannot readily be obtained by cross breeding, mutagenesis or natural recombination. Typically, one or more genes are integrated into the genome of a plant in order to add a trait or improve a trait. These integrated genes are also referred to as transgenes in the art, while plant comprising such transgenes are referred to as transgenic plants. The process of plant transformation usually produces several transformation events, which differ in the genomic locus in which a transgene has been integrated. Plants comprising a specific transgene on a specific genomic locus are usually described as comprising a specific “event”, which is referred to by a specific event name. Traits which have been introduced in plants or have been modified include in particular herbicide tolerance, insect resistance, increased yield and tolerance to abiotic conditions, like drought.

Herbicide tolerance has been created by using mutagenesis as well as using genetic engineering. Plants which have been rendered tolerant to acetolactate synthase (ALS) inhibitor herbicides by conventional methods of mutagenesis and breeding comprise plant varieties commercially available under the name Clearfield®. However, most of the herbicide tolerance traits have been created via the use of transgenes.

Herbicide tolerance has been created to glyphosate, glufosinate, 2,4-D, dicamba, oxynil herbicides, like bromoxynil and ioxynil, sulfonylurea herbicides, ALS inhibitor herbicides and 4-hydroxyphenylpyruvate dioxygenase (HPPD) inhibitors, like isoxaflutole and mesotrione.

Transgenes which have been used to provide herbicide tolerance traits comprise: for tolerance to glyphosate: cp4 epsps, epsps grg23ace5, mepsps, 2mepsps, gat4601, gat4621 and goxv247, for tolerance to glufosinate: pat and bar, for tolerance to 2,4-D: aad-1 and aad-12, for tolerance to dicamba: dmo, for tolerance to oxynil herbicies: bxn, for tolerance to sulfonylurea herbicides: zm-hra, csr1-2, gm-hra, S4-HrA, for tolerance to ALS inhibitor herbicides: csr1-2, for tolerance to HPPD inhibitor herbicides: hppdPF, W336 and avhppd-03.

Transgenic corn events comprising herbicide tolerance genes are for example, but not excluding others, DAS40278, MON801, MON802, MON809, MON810, MON832, MON87411, MON87419, MON87427, MON88017, MON89034, NK603, GA21, MZHGOJG, HCEM485, VCOØ1981-5, 676, 678, 680, 33121, 4114, 59122, 98140, Bt10, Bt176, CBH-351, DBT418, DLL25, MS3, MS6, MZIR098, T25, TC1507 and TC6275.

Transgenic soybean events comprising herbicide tolerance genes are for example, but not excluding others, GTS 40-3-2, MON87705, MON87708, MON87712, MON87769, MON89788, A2704-12, A2704-21, A5547-127, A5547-35, DP356043, DAS44406-6, DAS68416-4, DAS81419-2, GU262, SYHTØH2, W62, W98, FG72 and CV127.

Transgenic cotton events comprising herbicide tolerance genes are for example, but not excluding others, 19-51a, 31707, 42317, 81910, 281-24-236, 3006-210-23, BXN10211, BXN10215, BXN10222, BXN10224, MON1445, MON1698, MON88701, MON88913, GHB119, GHB614, LLCotton25, T303-3 and T304-40.

Transgenic canola events comprising herbicide tolerance genes are for example, but not excluding others, MON88302, HCR-1, HCN10, HCN28, HCN92, MS1, MS8, PHY14, PHY23, PHY35, PHY36, RF1, RF2 and RF3.

Insect resistance has mainly been created by transferring bacterial genes for insecticidal proteins to plants. Transgenes which have most frequently been used are toxin genes of Bacillus spec. and synthetic variants thereof, like cry1A, cry1Ab, cry1Ab-Ac, cry1Ac, cry1A.105, cry1F, cry1Fa2, cry2Ab2, cry2Ae, mcry3A, ecry3.1Ab, cry3Bb1, cry34Ab1, cry35Ab1, cry9C, vip3A(a), vip3Aa20. However, also genes of plant origin have been transferred to other plants. In particular genes coding for protease inhibitors, like CpTI and pinII. A further approach uses transgenes in order to produce double stranded RNA in plants to target and downregulate insect genes. An example for such a transgene is dvsnf7.

Transgenic corn events comprising genes for insecticidal proteins or double stranded RNA are for example, but not excluding others, Bt10, Bt11, Bt176, MON801, MON802, MON809, MON810, MON863, MON87411, MON88017, MON89034, 33121, 4114, 5307, 59122, TC1507, TC6275, CBH-351, MIR162, DBT418 and MZIR098.

Transgenic soybean events comprising genes for insecticidal proteins are for example, but not excluding others, MON87701, MON87751 and DAS-81419.

Transgenic cotton events comprising genes for insecticidal proteins are for example, but not excluding others, SGK321, MON531, MON757, MON1076, MON15985, 31707, 31803, 31807, 31808, 42317, BNLA-601, Event1, COT67B, COT102, T303-3, T304-40, GFM Cry1A, GK12, MLS 9124, 281-24-236, 3006-210-23, GHB119 and SGK321.

Increased yield has been created by increasing ear biomass using the transgene athb17, being present in corn event MON87403, or by enhancing photosynthesis using the transgene bbx32, being present in the soybean event MON87712.

Crops comprising a modified oil content have been created by using the transgenes: gm-fad2-1, Pj.D6D, Nc.Fad3, fad2-1A and fatb1-A. Soybean events comprising at least one of these genes are: 260-05, MON87705 and MON87769.

Tolerance to abiotic conditions, in particular to tolerance to drought, has been created by using the transgene cspB, comprised by the corn event MON87460 and by using the transgene Hahb4, comprised by soybean event IND-ØØ41Ø-5.

Traits are frequently combined by combining genes in a transformation event or by combining different events during the breeding process. Preferred combination of traits are herbicide tolerance to different groups of herbicides, insect tolerance to different kind of insects, in particular tolerance to lepidopteran and coleopteran insects, herbicide tolerance with one or several types of insect resistance, herbicide tolerance with increased yield as well as a combination of herbicide tolerance and tolerance to abiotic conditions.

Plants comprising singular or stacked traits as well as the genes and events providing these traits are well known in the art. For example, detailed information as to the mutagenized or integrated genes and the respective events are available from websites of the organizations “International Service for the Acquisition of Agri-biotech Applications (ISAAA)” (http://www.isaaa.org/gmapprovaldatabase) and the “Center for Environmental Risk Assessment (CERA)” (http://cera-gmc.org/GMCropDatabase), as well as in patent applications, like EP3028573 and WO2017/011288.

The use of herbicidal compositions according to the invention on crops may result in effects which are specific to a crop comprising a certain gene or event. These effects might involve changes in growth behavior or changed resistance to biotic or abiotic stress factors. Such effects may in particular comprise enhanced yield, enhanced resistance or tolerance to insects, nematodes, fungal, bacterial, mycoplasma, viral or viroid pathogens as well as early vigour, early or delayed ripening, cold or heat tolerance as well as changed amino acid or fatty acid spectrum or content.

Furthermore, plants are also covered that contain by the use of recombinant DNA techniques a modified amount of ingredients or new ingredients, specifically to improve raw material production, e.g., potatoes that produce increased amounts of amylopectin (e.g. Amflora® potato, BASF SE, Germany).

Furthermore, it has been found that the herbicidal compositions according to the invention are also suitable for the defoliation and/or desiccation of plant parts, for which crop plants such as cotton, potato, oilseed rape, sunflower, soybean or field beans, in particular cotton, are suitable. In this regard herbicidal compositions have been found for the desiccation and/or defoliation of plants, processes for preparing these compositions, and methods for desiccating and/or defoliating plants using the herbicidal compositions according to the invention.

As desiccants, herbicidal compositions according to the invention are suitable in particular for desiccating the above-ground parts of crop plants such as potato, oilseed rape, sunflower and soybean, but also cereals. This makes possible the fully mechanical harvesting of these important crop plants.

Also of economic interest is the facilitation of harvesting, which is made possible by concentrating within a certain period of time the dehiscence, or reduction of adhesion to the tree, in citrus fruit, olives and other species and varieties of pomaceous fruit, stone fruit and nuts. The same mechanism, i.e. the promotion of the development of abscission tissue between fruit part or leaf part and shoot part of the plants is also essential for the controlled defoliation of useful plants, in particular cotton.

Moreover, a shortening of the time interval in which the individual cotton plants mature leads to an increased fiber quality after harvesting.

The herbicidal composition may be applied in or on permanent cropland, or on permanent crops.

A permanent crop is one produced from plants which last for many seasons, rather than being re-planted after each harvest. Permanent crops are grown on permanent crop land in the form of agricultural land that includes grasslands and shrublands, e.g. used to grow grape vines or coffee; orchards used to grow fruit or olives; and forested plantations, e.g. used to grow nuts or rubber. It does not include, however, tree farms intended to be used for wood or timber.

Preferred permanent croplands in the context of the present invention are plantations, grasslands and shrublands. Preferably, the permanent crops in the context of the present invention are plantation crops, and preferably are selected from the group consisting fruit crops and orchard crops (preferably fruit trees, citrus trees, mango trees, olive trees, grape vines, coffee, cocoa, tea, and berries (such as strawberries, raspberries, blueberries and currants)), Musaceae sp. crops (for example banana or plantain crops), nut trees (preferably almond trees, walnut trees, pistachio trees, pecan trees, hazelnut trees), oil palm trees, rubber trees, sugarcane and cotton.

More preferably, the permanent crops are fruit trees (preferably pome fruit trees and stone fruit trees; preferred fruit trees are apple trees, pear trees, apricot trees, plum trees, cherry trees, peach trees), olive trees, grape vines, coffee, tea), Musaceae sp. crops (preferably banana crops or plantain crops), nut trees (preferably almond trees, walnut trees, pistachio trees, pecan trees, hazelnut trees), oil palm trees, rubber trees, and citrus crops (preferably lemon, orange or grapefruit crops). Even more preferably, the permanent crops are selected from the group consisting of apple trees, pear trees, apricot trees, plum trees, cherry trees, peach trees, olive trees, grape vines, coffee, tea, banana crops, nut trees (preferably almond trees, walnut trees, pistachio trees), oil palm trees, rubber trees, and citrus crops (preferably lemon, orange or grapefruit crops). Particularly preferably, the permanent crops are selected from the group consisting of apple trees, pear trees, apricot trees, plum trees, cherry trees, peach trees, olive trees, grape vines, coffee, tea, banana crops, almond trees, walnut trees, oil palm trees, rubber trees, lemon crops, orange crops and grapefruit crops

The herbicidal composition may also be applied on row crops and as well on specialty crops.

Row crops can be planted in rows wide enough to allow it to be tilled or otherwise cultivated by agricultural machinery, machinery tailored for the seasonal activities of row crops. The particularity of row crops is that they are planted and cultivated on a seasonal or yearly basis. Therefore, such crops yield products and profit relatively quickly and predictably. A row crop is one produced from plants which last for many seasons, rather than being re-planted after each harvest. Examples of row crops include soybeans, corn, canola, cotton, cereals or rice, but as well sunflower, potato, dry bean, field pea, flax, safflower, buckwheat and sugar beets.

Specialty crops are to be understood as fruits, vegetables or other speciality or plantation permanent crops such as trees, nuts, vines, (dried) fruits, ornamentals, oil palm, banana, rubber and the like, Horticulture and nursery crops, including floriculture, may also fall under the definition of speciality crops. Vegetable crops includes for example aubergine, beans, bell pepper, cabbage, chili, cucumber, eggplant, lettuce, melon, onion, potato, sweet potato, spinach and tomato. Plants being considered specialty crops are in general intensively cultivated. For weed control in vegetable crops, it may be desirable to shield the crops from contact with the spray solution that contains the herbicidal mixture according to the present invention.

In general, the crops which may be treated, may be of conventional origin or may be herbicide tolerant crops, preferably glufosinate tolerant crops. The herbicidal composition shows high herbicidal effects also against select crop plants, such as barley and soybean. This effect can be used to control crop plants in crop rotation methods of previously grown crop cultures. Typically, residual crop plants from previous rotation cycles remain after harvest and continue to grow within the subsequently grown crop variety. This reduces the yield since the crop plants of two different crop rotation cycles compete on the same locus of growth. The herbicidal composition may thus be applied to control residual crop plants from previous crop rotation cycles to allow for a homogeneous coverage with the subsequent crop plant.

In a preferred embodiment, the herbicidal composition is applied once, twice or three times per Gregorian calendar year, i.e. in one application, in two applications or in three applications per year according to the Gregorian calendar. In a preferred embodiment, the herbicidal composition is applied twice per Gregorian calendar year, i.e. in two applications per year according to the Gregorian calendar. In an alternatively preferred embodiment, the herbicidal composition is applied one time per Gregorian calendar year, i.e. in one application per year according to the Gregorian calendar. In a preferred embodiment, the herbicidal composition is applied one time in about 12 months, i.e. in one application in about 12 months. In an alternative preferred embodiment, the herbicidal composition is applied between one and ten times per Gregorian calendar year, i.e. in up to ten applications per year according to the Gregorian calendar. This alternative preferred method is of particular usefulness in permanent crops, in particular those grown under tropical conditions; in which case weeds grow vigorously at any time of the year, and herbicide applications are to be re-peated as soon as the previous treatment loses its effectiveness and weeds start to regrow.

The herbicidal compositions are preferably used in post-emergence applications.

The invention includes the use and methods of application of the herbicidal composition for controlling undesirable vegetation in crops in a burndown program, wherein the crop is produced by genetic engineering or by breeding, are tolerant to one or more herbicides and/or resistant to pathogens such as plant-pathogenous fungi, and/or to attack by insects; preferably tolerant to glufosinate.

Preferred are crops, which are tolerant to glufosinate, wherein the glufosinate tolerant crop plant is preferably selected from the group consisting of rice, canola, soybean, corn and cotton plants.

Transgenic corn events comprising glufosinate tolerance genes are for example, but not excluding others, 5307 x MIR604 x Bt11 x TC1507 x GA21 x MIR162 (event code: SYN-Ø53Ø7-1 x SYN-IR6Ø4-5 x SYN-BTØ11-1 x DAS-Ø15Ø7-1 x MON-ØØØ21-9 x SYN-IR162-4, gene: pat, e.g. commercially available as Agrisure® Duracade™ 5222), 59122 (event code: DAS-59122-7, gene: pat, e.g. commercially available as Herculex™ RW), 5307 x MIR604 x Bt11 x TC1507 x GA21 (event code: SYN-Ø53Ø7-1 x SYN-IR6Ø4-5 x SYN-BTØ11-1 x DAS-Ø15Ø7-1 x MONØØØ21-9, gene: pat, e.g. commercially available as Agrisure® Duracade™ 5122), 59122 x NK603 (event code: DAS-59122-7 x MON-ØØ6Ø3-6, gene: pat, e.g. commercially available as Herculex™ RW Roundup Ready™ 2), Bt10 (gene: pat, e.g. commercially available as Bt10), Bt11 (X4334CBR, X4734CBR) (event code: SYN-BTØ11-1, gene: pat, e.g. commercially available as Agrisure™ CB/LL), BT11 x 59122 x MIR604 x TC1507 x GA21 (event code: SYN-BTØ11-1 x DAS-59122-7 x SYN-IR6Ø4-5 x DAS-Ø15Ø7-1 x MON-ØØØ21-9, gene: pat, e.g. commercially available as Agrisure® 3122), Bt11 x GA21 (event code: SYN-BTØ11-1 x MON-ØØØ21-9, gene: pat, e.g. commercially available as Agrisure™ GT/CB/LL), Bt11 x MIR162 (event code: SYN-BTØ11-1 x SYN-IR162-4, gene: pat, e.g. commercially available as Agrisure® Viptera™ 2100), Bt11 x MIR162 x GA21 (event code: SYN-BTØ11-1 x SYN-IR162-4 x MON-ØØØ21-9, gene: pat, e.g. commercially available as Agrisure® Viptera™ 3110), BT11 x MIR162 x MIR604 (event code: SYN-BTØ11-1 x SYN-IR162-4 x SYN-IR6Ø4-5, gene: pat, e.g. commercially available as Agrisure® Viptera ™ 3100), Bt11 x MIR162 x MIR604 x GA21 (event code: SYN-BTØ11-1 x SYN-IR162-4 x SYN-IR6Ø4-5 x MON-ØØØ21-9, gene: pat, e.g. commercially available as Agrisure® Viptera™ 3111, Agrisure® Viptera™ 4), Bt11 x MIR162 x TC1507 x GA21 (event code: SYN-BTØ11-1 x SYN-IR162-4 x DAS-Ø15Ø7-1 x MON-ØØØ21-9, gene: pat, e.g. commercially available as Agrisure™ Viptera 3220), Bt11 x MIR604 (event code: SYN-BTØ11-1 x SYN-IR6Ø4-5, gene: pat, e.g. commercially available as Agrisure™ CB/LL/RW), BT11 x MIR604 x GA21 (event code: SYN-BTØ11-1 x SYN-IR6Ø4-5 x MON-ØØØ21-9, gene: pat, e.g. commercially available as Agrisure™ 3000GT), Bt176 (176) (event code: SYN-EV176-9, gene: bar, e.g. commercially available as NaturGard KnockOut™, Maximizer™), CBH-351 (event code: ACS-ZMØØ4-3, gene: bar, e.g. commercially available as StarIink™ Maize), DBT418 (event code: DKB-89614-9, gene: bar, e.g. commercially available as Bt Xtra ™ Maize), MON89034 x TC1507 x MON88017 x 59122 (event code: MON-89Ø34-3 x DAS-Ø15Ø7-1 x MON-88Ø17-3 x DAS-59122-7, gene: pat, e.g. commercially available as Genuity® SmartStax™), MON89034 x TC1507 x NK603 (event code: MON-89Ø34-3 x DAS-Ø15Ø7-1 x MON-ØØ6Ø3-6, gene: pat, e.g. commercially available as Power Core™), NK603 x T25 (event code: MON-ØØ6Ø3-6 x ACS-ZMØØ3-2, gene: pat, e.g. commercially available as Roundup Ready™ Liberty Link™ Maize), T14 (event code: ACS-ZMØØ2-1, gene: pat, e.g. commercially available as Liberty Link™ Maize), T25 (event code: ACS-ZMØØ3-2, gene: pat, e.g. commercially available as Liberty Link™ Maize), T25 x MON810 (event code: ACS-ZMØØ3-2 x MON-ØØ81Ø-6, gene: pat, e.g. commercially available as Liberty Link™ Yieldgard™ Maize), TC1507 (event code: DAS-Ø15Ø7-1, gene: pat, e.g. commercially available as Herculex™ I, Herculex™ CB), TC1507 x 59122 x MON810 x MIR604 x NK603 (event code: DAS-Ø15Ø7-1 x DAS-59122-7 x MON-ØØ81Ø-6 x SYN-IR6Ø4-5 x MON-ØØ6Ø3, gene: pat, e.g. commercially available as Optimum ™ Intrasect Xtreme), TC1507 x 59122 (event code: DAS-Ø15Ø7-1 x DAS-59122-7, gene: pat, e.g. commercially available as Herculex XTRA™), TC1507 x 59122 x MON810 x NK6Ø3 (event code: DAS-Ø15Ø7-1 x DAS-59122-7 x MON-ØØ81Ø-6 x MON-ØØ6Ø3-6, gene: pat, e.g. commercially available as Optimum™ Intrasect XTRA), TC1507 x 59122 x NK603 (event code: DAS-Ø15Ø7-1 x DAS-59122-7 x MON-ØØ6Ø3-6, gene: pat, e.g. commercially available as Herculex XTRA™ RR), TC1507 x MIR604 x NK603 (event code: DAS-Ø15Ø7-1 x SYN-IR6Ø4-5 x MON-ØØ6Ø3-6, gene: pat, e.g. commercially available as Optimum™ TRIsect), TC1507 x MON810 x NK603 (event code: DAS-Ø15Ø7-1 x MON-ØØ81Ø-6 x MON-ØØ6Ø3-6, gene: pat, e.g. commercially available as Optimum™ Intrasect), TC1507 x NK603 (event code: DAS-Ø15Ø7-1 x MON-ØØ6Ø3-6, gene: pat, e.g. commercially available as Herculex™ I RR), 3272 x Bt11 (event code:, SYN-E3272-5 x SYN-BTØ11-1 gene: pat), 3272 x Bt11 x GA21 (event code: SYN-E3272-5 x SYN-BTØ11-1 x MON-ØØØ21-9, gene: pat), 3272 x Bt11 x MIR604 (event code: SYN-E3272-5 x SYN-BTØ11-1 x SYN-IR604-5, gene: pat), 3272 x BT11 x MIR604 x GA21 (event code: SYN-E3272-5 x SYN-BTØ11-1 x SYN-IR6Ø4-5 x MON-ØØØ21-9, gene: pat), 33121 (event code: DP-Ø33121-3, gene: pat), 4114 (event code: DP-ØØ4114-3, gene: pat), 59122 x GA21 (event code: DAS-59122-7 x MON-ØØØ21-9, gene: pat), 59122 x MIR604 (event code: DAS-59122-7 x SYN-IR6Ø4-5, gene: pat), 5307 x MIR604 x Bt11 x TC1507 x GA21 x MIR162 (event code:, gene: pat), 59122 x MIR604 x GA21 (event code: DAS-59122-7 x SYN-IR6Ø4-5 x MON-ØØØ21-9, gene: pat), 59122 x MIR604 x TC1507 (event code: DAS-59122-7 x SYN-IR6Ø4-5 x DAS-Ø15Ø7-1, gene: pat), 59122 x MIR604 x TC1507 x GA21 (event code:, gene: pat), (event code: DAS-59122-7 x SYN-IR6Ø4-5 x DAS-Ø15Ø7-1 x MON-ØØØ21-9, gene: pat), 59122 x MON810 (event code: DAS-59122-7 x MON-ØØ81Ø-6, gene: pat), 59122 x MON810 x NK603 (event code: DAS-59122-7 x MON-ØØ81Ø-6 x MON-ØØ6Ø3-6, gene: pat), 59122 x TC1507 x GA21 (event code: DAS-59122-7 x DAS-Ø15Ø7-1 x MON-ØØØ21-9, gene: pat), 676 (event code: PH-ØØØ676-7, gene: pat), 678 (event code: PH-ØØØ678-9, gene: pat), 680 (event code: PH-ØØØ68Ø-2, gene: pat), 98140 x 59122 (event code: DP-Ø9814Ø-6 x DAS-59122-7, gene: pat), 98140 x TC1507 (event code: DP-Ø9814Ø-6 x DAS-Ø15Ø7-1, gene: pat), 98140 x TC1507 x 59122 (event code: DP-Ø9814Ø-6 x DAS-Ø15Ø7-1 x DAS-59122-7, gene: pat), 59122 x MON88017 (event code: DAS-59122-7 x MON88Ø17-3, gene: pat), Bt11 x 59122 (event code: SYN-BTØ11-1 x DAS-59122-7, gene: pat), Bt11 x 59122 x GA21 (event code: SYN-BTØ11-1 x DAS-59122-7 x MON-ØØØ21-9, gene: pat), Bt11 x 59122 x MIR604 (event code: SYN-BTØ11-1 x DAS-59122-7 x SYN-IR6Ø4-5, gene: pat), Bt11 x 59122 x MIR604 x GA21 (event code: SYN-BTØ11-1 x DAS-59122-7 x SYN-IR6Ø4-5 x MON-ØØØ21-9, gene: pat), Bt11 x 59122 x MIR604 x TC1507 (event code: Bt11 x 59122 x MIR604 x TC1507, gene: pat), Bt11 x 59122 x TC1507 (event code: SYN-BTØ11-1 x DAS-59122-7 x DAS-Ø15Ø7-1, gene: pat), Bt11 x 59122 x TC1507 x GA21 (event code: SYN-BTØ11-1 x DAS-59122-7 x DAS-Ø15Ø7-1 x MON-ØØØ21-9, gene: pat), Bt11 x MIR162 x TC1507 (event code: SYN-BTØ11-1 x SYN-IR162-4 x DAS-Ø15Ø7-1, gene: pat), Bt11 x MIR604 x TC1507 (event code: SYN-BTØ11-1 x SYN-IR6Ø4-5 x DAS-Ø15Ø7-1, gene: pat), Bt11 x TC1507 (event code: SYN-BTØ11-1 x DAS-Ø15Ø7-1, gene: pat), Bt11 x TC1507 x GA21 (event code: SYN-BTØ11-1 x DAS-Ø15Ø7-1 x MON-ØØØ21-9, gene: pat), GA21 x T25 (event code: MON-ØØØ21-9 x ACS-ZMØØ3-2, gene: pat), MIR162 x TC1507 (event code: SYN-IR162-4 x DAS-Ø15Ø7-1, gene: pat), MIR162 x TC1507 x GA21 (event code: SYN-IR162-4 x DAS-Ø15Ø7-1 x MON-ØØØ21-9, gene: pat), MIR604 x TC1507 (event code: SYN-IR6Ø4-5 x DAS-Ø15Ø7-1, gene: pat), MON87427 x MON89Ø34 x TC15Ø7 x MON88Ø17 x 59122 (event code: MON-87427-7 x MON-89Ø34-3 x DAS-Ø15Ø7-1 x MON-88Ø17-3 x DAS-59122-7, gene: pat), MON89034 x 59122 (event code: MON-89Ø34-3 x DAS-59122-7, gene: pat), MON89Ø34 x 59122 x MON88017 (event code:, gene: pat), MON89034 x TC1507 (event code: MON-89Ø34-3 x DAS-59122-7 x MON-88Ø17-3, gene: pat), (event code: MON-89Ø34-3 x DAS-Ø15Ø7-1, gene: pat), MIR604 x TC1507 (event code: SYN-IR6Ø4-5 x DAS-Ø15Ø7-1, gene: pat), MON87427 x MON89Ø34 x TC15Ø7 x MON88Ø17 x 59122 (event code: MON-87427-7 x MON-89034-3 x DAS-01507-1 x MON-88017-3 x DAS-59122-7, gene: pat), MON89034 x 59122 (event code: MON-89034-3 x DAS-59122-7, gene: pat), MON89034 x 59122 x MON88017 (event code:, gene: pat), MON89Ø34 x TC1507 (event code: MON-89Ø34-3 x DAS-59122-7 x MON-88Ø17-3, gene: pat), (event code: MON-89Ø34-3 x DAS-Ø15Ø7-1, gene: pat), DLL25 (B16) (event code: DKB-8979Ø-5, gene: bar), MIR604 x TC1507 (event code: SYN-IR6Ø4-5 x DAS-Ø15Ø7-1, gene: pat), MON87427 x MON89Ø34 x TC15Ø7 x MON88Ø17 x 59122 (event code: MON-87427-7 x MON-89Ø34-3 x DAS-Ø15Ø7-1 x MON-88Ø17-3 x DAS-59122-7, gene: pat), MON89034 x 59122 (event code: MON-89Ø34-3 x DAS-59122-7, gene: pat), MON89034 x 59122 x MON88017 (event code: MON-89Ø34-3 x DAS-59122-7 x MON-88Ø17-3, gene: pat), MON89034 x TC1507 (event code: MON-89Ø34-3 x DAS-Ø15Ø7-1, gene: pat), MON89034 x TC1507 x 59122 (event code: MON-89Ø34-3 x DAS-Ø15Ø7-1 x DAS-59122-7, gene: pat), MON89034 x TC1507 x MON88017 (event code: MON-89Ø34-3 x DAS-Ø15Ø7-1 x MON-88Ø17-3, gene: pat), MON89034 x TC1507 x MON88017 x 59122 x DAS40278 (event code: MON-89Ø34-3 x DAS-Ø15Ø7-1 x MON-88Ø17-3 x DAS-59122-7 x DAS-4Ø278-9, gene: pat), MON89034 x TC1507 x MON88017 x DAS40278 (event code: MON-89Ø34-3 x DAS-Ø15Ø7-1 x MON-88Ø17-3 x DAS-59122-7 x DAS-4Ø278-9, gene: pat), MON89034 x TC1507 x NK603 x DAS40278 (event code: MON-89Ø34-3 x DAS-Ø15Ø7-1 x MON-ØØ6Ø3-6 x DAS-4Ø278-9, gene: pat), NK603 x MON810 x 4114 x MIR 604 (event code: MON-ØØ6Ø3-6 x MON-00810-6 x DP004114-3 x SYN-IR604-4, gene: pat), TC1507 x MON810 x MIR604 x NK603 (event code: DAS-Ø15Ø7-1 x MON-ØØ81Ø-6 x SYN-IR6Ø4-5 x MON-ØØ6Ø3-6, gene: pat), TC1507 x 59122 x MON810 (event code: DAS-Ø15Ø7-1 x DAS-59122-7 x MON-ØØ81Ø-6, gene: pat), TC1507 x 59122 x MON88017 (event code: DAS-Ø15Ø7-1 x DAS-59122-7 x MON-88Ø17-3, gene: pat), TC1507 x GA21 (event code: DAS-Ø15Ø7-1 x MON-ØØØ21-9, gene: pat), TC1507 x MON810 (event code: DAS-Ø15Ø7-1 x MON-ØØ81Ø-6, gene: pat), TC1507 x MON810 x MIR162 x NK603 (event code: DAS-Ø15Ø7-1 x MON-ØØ81Ø-6 x SYN-IR162-4 x MON-ØØ6Ø3-6, gene: pat), 3272 x Bt11 x MIR604 x TC1507 x 5307 x GA21 (event code: SYN-E3272-5 x SYN-BTØ11-1 x SYN-IR6Ø4-5 x DAS-Ø15Ø7-1 x SYN-Ø53Ø7-1 x MON-ØØØ21-9, gene: pat), TC1507 x MIR162 x NK603 (event code: DAS-Ø15Ø7-1 x SYN-IR162-4 x MON-ØØ6Ø3-6, gene: pat), TC1507 x MON810 x MIR162 (event code: DAS-Ø15Ø7-1 x MON-00810-6 x SYN-IR162-4, gene: pat), MON87419 (event code: MON87419-8, gene: pat), TC1507 x MON88017 (event code: DAS-Ø15Ø7-1 x MON-88Ø17-3, gene: pat), TC6275 (event code: DAS-Ø6275-8, gene: bar), MZHG0JG (event code: SYN-ØØØJG-2, gene: pat), MZIR098 (event code: SYN-ØØØ98-3, gene: pat), Bt11 x MIR162 x MON89034 (event code: SYN-BTØ11-1 x SYN-IR162-4 x MON-89Ø34-3, gene: pat) and Bt11 x MIR162 x MON89Ø34 x GA21 (event code: SYN-BTØ11-1 x SYN-IR162-4 x MON-89Ø34-3 x MON-ØØØ21-9, gene: pat), 59122 x DAS40278 (event code: DAS-59122-7 x DAS-4Ø278-9, gene: pat), 59122 x MON810 x MIR604 (event code: DAS-59122-7 x MON-ØØ81Ø-6 x SYN-IR6Ø4-5, gene: pat), 59122 x MON810 x NK603 x MIR604 (event code: DAS-59122-7 x MON-ØØ81Ø-6 x MON-ØØ6Ø3-6 x SYN-IR6Ø4-5, gene: pat), 59122 x MON88017 x DAS40278 (event code: DAS-59122-7 x MON-88Ø17-3 x DAS-4Ø278-9, gene: pat), 59122 x NK603 x MIR604 (event code: DAS-59122-7 x MON-ØØ6Ø3-6 x SYN-IR6Ø4-5, gene: pat), Bt11 x 5307 (event code: SYN-BTØ11-1 x SYN-Ø53Ø7-1, gene: pat), Bt11 x 5307 x GA21 (event code: SYN-BTØ11-1 x SYN-Ø53Ø7-1 x MON-ØØØ21-9, gene: pat), Bt11 x MIR162 x 5307 (event code: SYN-BTØ11-1 x SYN-IR162-4 x SYN-Ø53Ø7-1, gene: pat), Bt11 x MIR162 x 5307 x GA21 (event code: SYN-BTØ11-1 x SYN-IR162-4 x SYN-Ø53Ø7-1 x MON-ØØØ21-9, gene: pat), BT11 x MIR162 x MIR604 x 5307 (event code: SYN-BTØ11-1 x SYN-IR162-4 x SYN-IR6Ø4-5 x SYN-Ø53Ø7-1, gene: pat), Bt11 x MIR162 x MIR604 x 5307 x GA21 (event code: SYN-BTØ11-1 x SYN-IR162-4 x SYN-IR6Ø4-5 x SYN-Ø53Ø7-1 xMON-ØØØ21-9, gene: pat), Bt11 x MIR162 x MIR604 x MON89034 x 5307 x GA21 (event code: SYN-BTØ11-1 x SYN-IR162-4 x SYN-IR604-5 x MON-89Ø34-3 x SYN-05307-1 x MON-ØØØ21-9, gene: pat), BT11 x MIR162 x MIR604 x TC1507 (event code: SYN-BTØ11-1 x SYN-IR162-4 x SYN-IR6Ø4-5 x DAS-Ø15Ø7-1, gene: pat), BT11 x MIR162 x MIR604 x TC1507 x 5307 (event code: SYN-BTØ11-1 x SYN-IR162-4 x SYN-IR6Ø4-5 x DAS-Ø15Ø7-1 x SYN-Ø53Ø7-1, gene: pat), Bt11 x MIR162 x MIR604 x TC1507 x GA21 (event code: SYN-BTØ11-1 x SYN-IR162-4 x SYN-IR6Ø4-5 x DAS-Ø15Ø7-1 x MON-ØØØ21-9, gene: pat), Bt11 x MIR162 x TC1507 x 5307 (event code: SYN-BTØ11-1 x SYN-IR162-4 x DAS-Ø15Ø7-1 x SYN-Ø53Ø7-1, gene: pat), BT11 x MIR162 x MIR604 x TC1507 x 5307 (event code: SYN-BTØ11-1 x SYN-IR162-4 x SYN-IR6Ø4-5 x DAS-Ø15Ø7-1 x SYN-Ø53Ø7-1, gene: pat), Bt11 x MIR162 x MIR604 x TC1507 x GA21 (event code: SYN-BTØ11-1 x SYN-IR162-4 x SYN-IR6Ø4-5 x DAS-Ø15Ø7-1 x MON-ØØØ21-9, gene: pat), Bt11 x MIR162 x TC1507 x 5307 (event code: SYN-BTØ11-1 x SYN-IR162-4 x DAS-Ø15Ø7-1 x SYN-Ø53Ø7-1, gene: pat), Bt11 x MIR162 x TC1507 x 5307 x GA21 (event code: SYN-BTØ11-1 x SYN-IR162-4 x DAS-Ø15Ø7-1 x SYN-Ø53Ø7-1 x MON-ØØØ21-9, gene: pat), Bt11 x MIR604 x 5307 (event code: SYN-BTØ11-1 x SYN-IR6Ø4-5 x SYN-Ø53Ø7-1, gene: pat), Bt11 x MIR604 x 5307 x GA21 (event code: SYN-BTØ11-1 x SYN-IR6Ø4-5 x SYN-Ø53Ø7-1 x MON-ØØØ21-9, gene: pat), Bt11 x MIR604 x TC1507 x 5307 (event code: SYN-BTØ11-1 x SYN-IR6Ø4-5 x DAS-Ø15Ø7-1 x SYN-Ø53Ø7-1, gene: pat), Bt11 x MIR604 x TC1507 x GA21 (event code: SYN-BTØ11-1 x SYN-IR6Ø4-5 x DAS-Ø15Ø7-1 x MON-ØØØ21-9, gene: pat), Bt11 x MON89034 (or Bt11 x MON89Ø34) (event code: SYN-BTØ11-1 x MON-89Ø34-3, gene: pat), Bt11 x MON89034 x GA21 (event code: SYN-BTØ11-1 x MON-89Ø34-3 x MON-ØØØ21-9, gene: pat), Bt11 x MON89Ø34 x GA21 (event code: SYN-BTØ11-1 x MON-89Ø34-3 x MON-ØØØ21-9, gene: pat), Bt11 x TC1507 x 5307 (event code: SYN-BTØ11-1 x DAS-Ø15Ø7-1 x SYN-Ø53Ø7-1, gene: pat), Bt11 x TC1507 x 5307 x GA21 (event code: SYN-BTØ11-1 x DAS-Ø15Ø7-1 x SYN-Ø53Ø7-1 x MON-ØØØ21-9, gene: pat), MIR162 x MIR604 x TC1507 x 5307 (event code: SYN-IR162-4 x SYN-IR6Ø4-5 x DAS-Ø15Ø7-1 x SYN-Ø53Ø7-1, gene: pat), MIR162 x MIR604 x TC1507 x 5307 x GA21 (event code: SYN-IR162-4 x SYN-IR6Ø4-5 x DAS-Ø15Ø7-1 x SYN-Ø53Ø7-1 x MON-ØØØ21-9, gene: pat), MIR162 x MIR604 x TC1507 x GA21 (event code: SYN-IR162-4 x SYN-IR6Ø4-5 x DAS-Ø15Ø7-1 x MON-ØØØ21-9, gene: pat), MIR162 x TC1507 x 5307 (event code: SYN-IR162-4 x DAS-Ø15Ø7-1 x SYN-Ø53Ø7-1, gene: pat), MIR162 x TC1507 x 5307 x GA21 (event code: SYN-IR162-4 x DAS-Ø15Ø7-1 x SYN-Ø53Ø7-1 x MON-ØØØ21-9, gene: pat), MIR604 x TC1507 x 5307 (event code: SYN-IR6Ø4-5 x DAS-Ø15Ø7-1 x SYN-Ø53Ø7-1, gene: pat), MIR162 x TC1507 x 5307 (event code: SYN-IR162-4 x DAS-Ø15Ø7-1 x SYN-Ø53Ø7-1, gene: pat), MIR162 x TC1507 x 5307 x GA21 (event code: SYN-IR162-4 x DAS-Ø15Ø7-1 x SYN-Ø53Ø7-1 x MON-ØØØ21-9, gene: pat), MIR604 x TC1507 x 5307 (event code: SYN-IR6Ø4-5 x DAS-Ø15Ø7-1 x SYN-Ø53Ø7-1, gene: pat), MIR604 x TC1507 x 5307 xGA21 (event code: SYN-IR6Ø4-5 x TC1507 x SYN-Ø53Ø7-1 x MON-ØØØ21-9, gene: pat), MIR604 x TC1507 x GA21 (event code: SYN-IR6Ø4-5 x TC1507 x MON-ØØØ21-9, gene: pat), MON87427 x 59122 (event code MON-87427-7 x DAS-59122-7, gene: pat), MON87427 x MON89034 x 59122 (event code: MON-87427-7 x MON-89Ø34-3 x DAS-59122-7, gene: pat), MON87427 x MON89034 x MON88017 x 59122 (event code: MON-87427-7 x MON-89Ø34-3 x MON-88Ø17-3 x 59122, gene: pat), MON87427 x MON89034 x TC1507 (event code: MON-87427-7 x MON-89Ø34-3 x DAS-Ø15Ø7-1, gene: pat), MON87427 x MON89034 x TC1507 x 59122 (event code: MON-87427-7 x MON-89Ø34-3 x DAS-Ø15Ø7-1 x DAS-59122-7, gene: pat), MON87427 x MON89034 x TC1507 x MON87411 x 59122 (event code: MON-87427-7 x MON-89Ø34-3 x DAS-Ø15Ø7-1 x MON-87411-9 x DAS-59122-7, gene: pat), MON87427 x MON89034 x TC1507 x MON87411 x 59122 x DAS40278 (event code: MON-87427-7 x MON-89Ø34-3 x DAS-Ø15Ø7-1 x MON-87411-9 x DAS-59122-7 x DAS-4Ø278-9, gene: pat), MON87427 x MON89034 x TC1507 x MON88017 (event code: MON-87427-7 x MON-89Ø34-3 x DAS-Ø15Ø7-1 x MON-88Ø17-3, gene: pat), MON87427 x TC1507 (event code: MON-87427-7 x DAS-Ø15Ø7-1, gene: pat), MON87427 x TC1507 x 59122 (event code: MON-87427-7 x DAS-Ø15Ø7-1 x DAS-59122-7, gene: pat), MON87427 x TC1507 x MON88017 (event code: MON-87427-7 x DAS-Ø15Ø7-1 x MON-88Ø17-3, gene: pat), MON87427 x TC1507 x MON88017 x 59122 (event code: MON-87427-7 x DAS-Ø15Ø7-1 x MON-88Ø17-3 x DAS-59122-7, gene: pat), MON89034 x 59122 x DAS40278 (event code: MON-89Ø34-3 x DAS-59122-7 x DAS-4Ø278-9, gene: pat), MON89034 x 59122 x MON88017 x DAS40278 (event code: MON-89Ø34-3 x DAS-59122-7 x MON-88Ø17-3 x DAS-4Ø278-9, gene: pat), MON89034 x TC1507 x 59122 x DAS40278 (event code: MON-89Ø34-3 x DAS-Ø15Ø7-1 x DAS-59122-7 x DAS-4Ø278-9, gene: pat), MON89034 x TC1507 x DAS40278 (event code: MON-89Ø34-3 x DAS-Ø15Ø7-1 x DAS-4Ø278-9, gene: pat), MON89034 x TC1507 x NK603 x MIR162 (event code: MON-89Ø34-3 x DAS-Ø15Ø7-1 x MON-ØØ6Ø3-6 x SYN-IR162-4, gene: pat), TC1507 x 5307 (event code: DAS-Ø15Ø7-1 x SYN-Ø53Ø7-1, gene: pat), TC1507 x 5307 x GA21 (event code: DAS-Ø15Ø7-1 x SYN-Ø53Ø7-1 x MON-ØØØ21-9, gene: pat), TC1507 x 59122 x DAS40278 (event code: DAS-Ø15Ø7-1 x DAS-59122-7 x DAS-4Ø278-9, gene: pat), TC1507 x 59122 x MON810 x MIR604 (event code: DAS-Ø15Ø7-1 x DAS-59122-7 x MON-ØØ81Ø-6 x SYN-IR6Ø4-5, gene: pat), TC1507 x 59122 x MON88017 x DAS40278 (event code: DAS-Ø15Ø7-1 x DAS-59122-7 x MON-88Ø17-3 x DAS-4Ø278-9, gene: pat), TC1507 x 59122 x NK603 x MIR604 (event code:, gene: pat) DAS-Ø15Ø7-1 x DAS-59122-7 x MON-ØØ6Ø3-6 x SYN-IR6Ø4-5, TC1507 x DAS40278 (event code: DAS-Ø15Ø7-1 x DAS-4Ø278-9, gene: pat), TC1507 x MON810 x MIR604 (event code: DAS-Ø15Ø7-1 x MON-ØØ81Ø-6 x SYN-IR6Ø4-5, gene: pat), TC1507 x MON810 x NK603 x MIR604 (event code: DAS-Ø15Ø7-1 x MON-00810-6 x MON-00603-6 x SYN-1R604-5, gene: pat), TC1507 x MON88017 x DAS40278 (event code: DAS-Ø15Ø7-1 x MON-88Ø17-3 x DAS-4Ø278-9, gene: pat) and TC1507 x NK603 x DAS40278 (event code: DAS-Ø15Ø7-1 x MON-ØØ6Ø3-6 x DAS-4Ø278-9, gene: pat).

Transgenic soybean events comprising glufosinate tolerance genes are for example, but not excluding others, A2704-12 (event code: ACS-GMØØ5-3, gene: pat , e.g. commercially available as Liberty Link™ soybean), A2704-21 (event code: ACS-GMØØ4-2, gene: pat, e.g. commercially available as Liberty Link™ soybean), A5547-127 (event code: ACS-GMØØ6-4, gene: pat, e.g. commercially available as Liberty Link™ soybean), A5547-35 (event code: ACS-GMØØ8-6, gene: pat, e.g. commercially available as Liberty Link™ soybean), GU262 (event code: ACS-GMØØ3-1, gene: pat, e.g. commercially available as Liberty Link™ soybean), W62 (event code: ACS-GMØØ2-9, gene: pat, e.g. commercially available as Liberty Link™ soybean), W98 (event code: ACS-GMØØ1-8, gene: pat, e.g. commercially available as Liberty Link™ soybean), DAS68416-4 (event code: DAS-68416-4, gene: pat, e.g. commercially available as Enlist™ Soybean), DAS44406-6 (event code: DAS-44406-6, gene: pat), DAS68416-4 x MON89788 (event code: DAS-68416-4 x MON-89788-1, gene: pat), SYHTØH2 (event code: SYN-000H2-5, gene: pat), DAS81419 x DAS44406-6 (event code: DAS-81419-2 x DAS-444Ø6-6, gene: pat) and FG72 x A5547-127 (event code: MST-FGØ72-3 x ACS-GMØØ6-4, gene: pat).

Transgenic cotton events comprising glufosinate tolerance genes are for example, but not excluding others, 3006-210-23 x 281-24-236 x MON1445 (event code: DAS-21Ø23-5 x DAS-24236-5 x MON-Ø1445-2, gene: bar, e.g. commercially available as WideStrike™ Roundup Ready™ Cotton), 3006-210-23 x 281-24-236 x MON88913 (event code: DAS-21Ø23-5 x DAS-24236-5 x MON-88913-8, gene: bar, e.g. commercially available as VVidestrike™ Roundup Ready Flex™ Cotton), 3006-210-23 x 281-24-236 x MON88913 x COT102 (event code: DAS-21Ø23-5 x DAS-24236-5 x MON-88913-8 x SYN-IR1Ø2-7, gene: pat, e.g. commercially available as Widestrike™ x Roundup Ready Flex™ x VIPCOT™ Cotton), GHB614 x LLCotton25 (event code: BCS-GHØØ2-5 x ACS-GHØØ1-3, gene: bar, e.g. commercially available as GlyTol ™ Liberty Link™), GHB614 x T304-40 x GHB119 (event code: BCS-GHØØ2-5 x BCS-GHØØ4-7 x BCS-GHØØ5-8, gene: bar, e.g. commercially available as Glytol™ x Twinlink™), LLCotton25 (event code: ACS-GHØØ1-3, gene: bar, e.g. commercially available as ACS-GHØØ1-3), GHB614 x T304-40 x GHB119 x COT102 (event code: BCS-GHØØ2-5 x BCS-GHØØ4-7 x BCS-GHØØ5-8 x SYN-IR1Ø2-7, gene: bar, e.g. commercially available as Glytol™ x Twinlink™ x VIPCOT™ Cotton), LLCotton25 x MON15985 (event code: ACS-GHØØ1-3 x MON-15985-7, gene: bar, e.g. commercially available as Fibermax™ Liberty Link™ Bollgard II ™), T304-40 x GHB119 (event code: BCS-GHØØ4-7 x BCS-GHØØ5-8, gene: bar, e.g. commercially available as TwinLink™ Cotton), GHB614 x T304-40 x GHB119 x COT102 (event code: BCS-GHØØ2-5 x BCS-GHØØ4-7 x BCS-GHØØ5-8 x SYN-IR1Ø2-7, gene: bar, e.g. commercially available as Glytol™ x Twinlink™ x VIPCOT™ Cotton), GHB119 (event code: BCS-GHØØ5-8, gene: bar), GHB614 x LLCotton25 x MON15985 (event code: CS-GHØØ2-5 x ACS-GHØØ1-3 x MON-15985-7, gene: bar), MON 887Ø1-3 (event code: MON88701, gene: bar), T303-3 (event code: BCS-GHØØ3-6, gene: bar), T304-40 (event code: BCS-GHØØ3-6, gene: bar), (event code: BCS-GHØØ4-7, gene: bar), 81910 (event code: DAS-81910-7, gene: pat), MON8870 (event code: MON 887Ø1-3, gene: bar), MON88701 x MON88913 (event code: MON 887Ø1-3 x MON-88913-8, gene: bar), MON88701 x MON88913 x MON15985 (event code: MON 887Ø1-3 x MON-88913-8 x MON-15985-7, gene: bar), 281-24-236 x 3006-210-23 x COT102 x 81910 (event code: DAS-24236-5 x DAS-21Ø23-5 x SYN-IR1Ø2-7 x DAS-81910-7, gene: pat), COT102 x MON15985 x MON88913 x MON887Ø1 (event code: SYN-IR1Ø2-7 x MON-15985-7 x MON-88913-8 x MON 88701-3, gene: bar) and 3006-210-23 x 281-24-236 x MON88913 x COT102 x 81910 (event code: DAS-21Ø23-5 x DAS-24236-5 x MON-88913-8 x SYN-IR1Ø2-7 x DAS-81910-7, gene: pat).

Transgenic canola events comprising glufosinate tolerance genes are for example, but not excluding others, HCN10 (Topas 19/2) (event code: , gene: bar, e.g. commercially available as Liberty Link™ Independence™), HCN28 (T45) (event code: ACS-BNØØ8-2, gene: pat, e.g. commercially available as InVigor™ Canola), HCN92 (Topas 19/2 (event code: ACS-BNØØ7-1, gene: bar, e.g. commercially available as Liberty Link™ Innovator™), MS1 (B91-4) (event code: ACS-BNØØ4-7, gene: bar, e.g. commercially available as InVigor™ Canola), MS1 x RF1 (PGS1) (event code: ACS-BNØØ4-7 x ACS-BNØØ1-4, gene: bar, e.g. commercially available as InVigor™ Canola), MS1 x RF2 (PGS2) (event code: ACS-BNØØ4-7 x ACS-BNØØ2-5, gene: bar, e.g. commercially available as InVigor™ Canola), MS1 x RF3 (event code: ACS-BNØØ4-7 x ACS-BNØØ3-6, gene: bar, e.g. commercially available as InVigor™ Canola), MS8 (event code: ACS-BNØØ5-8, gene: bar, e.g. commercially available as InVigor™ Canola), MS8 x RF3 (event code: ACS-BNØØ5-8 x ACS-BNØØ3-6, gene: bar, e.g. commercially available as InVigor™ Canola), RF1 (B93-101) (event code: ACS-BNØØ1-4, gene: bar, e.g. commercially available as InVigor™ Canola), RF2 (B94-2) (event code: ACS-BNØØ2-5, gene: bar, e.g. commercially available as InVigor™ Canola), RF3 (event code: ACS-BNØØ3-6, gene: bar, e.g. commercially available as InVigor™ Canola), MS1 x MON883Ø2 (event code: ACS-BNØØ4-7 x MON-883Ø2-9, gene: bar, e.g. commercially available as InVigor™ x TruFlex™ Roundup Ready™ Canola), MS8 x MON883Ø2 (event code: ACS-BNØØ5-8 x MON-883Ø2-9, gene: bar, e.g. commercially available as InVigor™ x TruFlex™ Roundup Ready™ Canola), RF1 x MON88302 (event code: ACS-BNØØ1-4 x MON-883Ø2-9, gene: bar, e.g. commercially available as InVigor™ x TruFlex™ Roundup Ready™ Canola), RF2 x MON8832 (event code: ACS-BNØØ2-5 x MON-883Ø2-9, gene: bar, e.g. commercially available as InVigor™ x TruFlex™ Roundup Ready™ Canola), HCN28 x MON88302 (event code: ACS-BNØØ8-2 x MON-883Ø2-9, gene: pat, e.g. commercially available as InVigor™ x TruFlex™ Roundup Ready™ Canola), HCN92 x MON88302 (event code: ACS-BNØØ7-1 x MON-883Ø2-9, gene: bar, e.g. commercially available as Liberty Link™ Innovator™ x TruFlex™ Roundup Ready™ Canola), HCR-1 (gene: pat), MON88302 x MS8 x RF3 (event code: MON-883Ø2-9 x ACS-BNØØ5-8 x ACS-BNØØ3-6, gene: bar), MON8832 x RF3 (event code: MON-883Ø2-9 x ACS-BNØØ3-6, gene: bar), MS8 x RF3 x GT73 (RT73) (event code:, gene: bar), PHY14 (event code: ACS-BNØØ5-8 x ACS-BNØØ3-6 x MON-ØØØ73-7, gene: bar), PHY23 (gene: bar), PHY35 (gene: bar) and PHY36 (gene: bar) and 73496 x RF3 (event code: DP-Ø73496-4 x ACS-BNØØ3-6, gene: bar). Transgenic rice events comprising glufosinate tolerance genes are for example, but not excluding others, LLRICE06 (event code: ACS-OSØØ1-4, e.g. commercially available as Liberty Link™ rice), LLRICE601 (event code: BCS-OSØØ3-7, e.g. commercially available as Liberty Link™ rice) and LLRICE62 (event code: ACS-OSØØ2-5, e.g. commercially available as Liberty Link™ rice).

The herbicidal compositions have an outstanding herbicidal activity against a broad spectrum of economically important harmful monocotyledonous and dicotyledonous harmful plants. Also here, post-emergence application is preferred.

Specifically, examples may be mentioned of some representatives of the monocotyledonous and dicotyledonous weed flora which can be controlled by the combinations according to the invention, without the enumeration being a restriction to certain species.

In the context of the present text, reference may be made to growth stages according to the BBCH monograph “Growth stages of mono-and dicotyledonous plants”, 2nd edition, 2001, ed. Uwe Meier, Federal Biological Research Centre for Agriculture and Forestry (Biologische Bundesanstalt für Land and Forstwirtschaft).

Examples of monocotyledonous harmful plants on which the glufosinate combinations act efficiently are from amongst the genera Hordeum spp., Echinochloa spp., Poa spp., Bromus spp., Digitaria spp., Eriochloa spp., Setaria spp., Pennisetum spp., Eleusine spp., Eragrostis spp., Panicum spp., Lolium spp., Brachiaria spp., Leptochloa spp., Avena spp., Cyperus spp., Axonopris spp., Sorghum spp., and Melinus spp.

Particular examples of monocotyledonous harmful plants species on which the herbicidal compositions act efficiently are selected from amongst the species Hordeum murinum, Echinochloa crus-galli, Poa annus, Bromus rubens L., Bromus rigidus, Bromus secalinus L., Digitaria sanguinalis, Digitaria insularis, Eriochloa gracilis, Setaria faberi, Setaria viridis, Pennisetum glaucum, Eleusine indica, Eragrostis pectinacea, Panicum miliaceum, Lolium multiflorum, Brachiaria platyphylla, Leptochloa fusca, Avena fatua, Cyperus compressus, Cyperus esculentes, Axonopris offinis, Sorghum halapense, and Melinus repens.

In a preferred embodiment, the herbicidal compositions are used to control monocotyledonous harmful plant species, more preferably monocoty-ledonous plants of the species Echinochloa spp., Digitaria spp., Setaria spp., Eleusine spp. and Bra-chiarium spp.

Examples of dicotyledonous harmful plants on which the herbicidal compositions act efficiently are from amongst the genera Amaranthus spp., Erigeron spp., Conyza spp., Polygonum spp., Medicago spp., Mollugo spp., Cyclospermum spp., Stellaria spp., Gnaphalium spp., Taraxacum spp., Oenothera spp., Amsinckia spp., Erodium spp., Erigeron spp., Senecio spp., Lamium spp., Kochia spp., Chenopodium spp., Lactuca spp., Malva spp., Ipomoea spp., Brassica spp., Sinapis spp., Urtica spp., Sida spp, Portulaca spp., Richardia spp., Ambrosia spp., Calandrinia spp., Sisymbrium spp., Sesbania spp., Capsella spp., Sonchus spp., Euphorbia spp., Helianthus spp., Coronopus spp., Salsola spp., Abutilon spp., Vicia spp., Epilobium spp., Cardamine spp., Picris spp., Trifolium spp., Galinsoga spp., Epimedium spp., Marchantia spp., Solanum spp., Oxalis spp., Metricaria spp., Plantago spp., Tribulus spp., Cenchrus spp. Bidens spp., Veronica spp., and Hypochaeris spp.

Particular examples of dicotyledonous harmful plants species on which the herbicidal compositions act efficiently are selected from amongst the species Amaranthus spinosus, Polygonum convolvulus, Medicago polymorpha, Mollugo verticillata, Cyclospermum leptophyllum, Stellaria media, Gnaphalium purpureum, Taraxacum officinale, Oenothera laciniata, Amsinckia intermedia, Erodium cicutarium, Erodium moschatum, Erigeron bonariensis (Conyza bonariensis), Senecio vulgaris, Lamium amplexicaule, Erigeron canadensis, Polygonum aviculare, Kochia scoparia, Chenopodium album, Lactuca serriola, Malva parviflora, Malva neglecta, Ipomoea hederacea, Ipomoea lacunose, Brassica nigra, Sinapis arvensis, Urtica dioica, Amaranthus blitoides, Amaranthus retroflexus, Amaranthus hybridus, Amaranthus lividus, Sida spinosa, Portulaca oleracea, Richardia scabra, Ambrosia artemisiifolia, Calandrinia cau-lescens, Sisymbrium irio, Sesbania exaltata, Capsella bursa-pastoris, Sonchus oleraceus, Euphorbia maculate, Helianthus annuus, Coronopus didymus, Salsola tragus, Abutilon theophrasti, Vicia ben-ghalensis L., Epilobium paniculatum, Cardamine spp, Picris echioides, Trifolium spp., Galinsoga spp., Epimedium spp., Marchantia spp., Solanum spp., Oxalis spp., Metricaria matriccarioides, Plantago spp., Tribulus terrestris, Salsola kali, Cenchrus spp., Bidens bipinnata, Veronica spp., and Hypochaeris radicata.

In a preferred embodiment, the herbicidal compositions are used to control dicotyledonous harmful plant species, more preferably dicotyledonous plants of the species Amaranthus spp., Erigeron spp., Conyza spp., Kochia spp. and Abutilon spp.

Herbicidal compositions are also suitable for controlling a large number of annual and perennial sedge weeds including Cyperus species such as purple nutsedge (Cyperus rotundus L.), yellow nutsedge (Cyperus esculentus L.), hime-kugu (Cyperus brevifolius H.), sedge weed (Cyperus microiria Steud), rice flatsedge (Cyperus iria L.), Cyperus difformis, Cyperus difformis L., Cyperus esculentus, Cyperus ferax, Cyperus flavus, Cyperus iria, Cyperus lanceolatus, Cyperus odoratus, Cyperus rotundus, Cyperus serotinus Rottb., Eleocharis acicularis, Eleocharis kuroguwai, Fimbristylis dichotoma, Fimbristylis miliacea, Scirpus grossus, Scirpus juncoides, Scirpus juncoides Roxb, Scirpus or Bolboschoenus maritimus, Scirpus or Schoenoplectus mucronatus, Scirpus planiculmis Fr. Schmidt and the like.

If the herbicidal compositions are applied post-emergence to the green parts of the plants, growth likewise stops drastically a very short time after the treatment and the weed plants remain at the growth stage of the point of time of application, or they die completely after a certain time, so that in this manner competition by the weeds, which is harmful to the crops, is eliminated at a very early point in time and in a sustained manner.

The herbicidal compositions are characterized by a rapidly commencing and long-lasting herbicidal action. As a rule, the rainfastness of the active compounds in the herbicide combinations according to the present invention is advantageous. In particular when the herbicidal compositions are employed application rates may be reduced, a broader spectrum of broad-leaved weeds and grass weeds maybe controlled, the herbicidal action may take place more rapidly, the duration of action may be longer, the harmful plants may be controlled better while using only one, or few, applications, and the application period which is possible to be extended.

The abovementioned properties and advantages are of benefit for weed control practice to keep agricultural crops free from undesired competing plants and thus to safeguard and/or increase the yields from the qualitative and/or quantitative point of view. These herbicidal compositions markedly exceed the technical state of the art with a view to the properties described. Owing to their herbicidal and plant-growth-regulatory properties, the herbicidal compositions can be employed for controlling harmful plants in genetically modified crops or crops obtained by mutation/selection. These crops are distinguished as a rule by particular, advantageous properties, such as resistances to herbicidal compositions or resistances to plant diseases or causative agents of plant diseases such as particular insects or microorganisms such as fungi, bacteria or viruses. Other particular properties relate, for example, to the harvested material with regard to quantity, quality, storability, composition and specific constituents. Thus, for example, transgenic plants are known whose starch content is increased or whose starch quality is altered, or those where the harvested material has a different fatty acid composition.

The present invention also relates to a method of controlling undesired vegetation (e.g. harmful plants), which comprises applying the herbicidal compositions, preferably by the post-emergence method, to harmful or undesired plants, parts of said harmful or undesired plants, or the area where the harmful or undesired plants grow, for example the area under cultivation. In the context of the present invention “controlling” denotes a significant reduction of the growth of the harmful plant(s) in comparison to the untreated harmful plants. Preferably, the growth of the harmful plant(s) is essentially diminished (60-79%), more preferably the growth of the harmful plant(s) is largely or fully suppressed (80-100%), and in particular the growth of the harmful plant(s) is almost fully or fully suppressed (90-100%).

Thus, in a further aspect, the present invention relates to a method for controlling undesired plant growth, and/or controlling harmful plants, comprising the step of applying the herbicidal composition (preferably in one of the preferred embodiments defined herein) onto the undesired plants or the harmful plants, on parts of the undesired plants or the harmful plants, or on the area where the undesired plants or the harmful plants grow.

The herbicidal composition(s) may be used for controlling undesirable vegetation in burndown programs, in industrial vegetation management and forestry, in vegetable and perennial crops and in turf and lawn, wherein the herbicidal composition(s) can be applied pre- or post-emergence, i.e. before, during and/or after emergence of the undesirable plants. Preferred is the application as post-emergence treatment, i.e. during and/or after emergence of the undesirable plants. Herein, the herbicidal composition(s) are applied to a locus where crops will be planted before planting or emergence of the crop.

In industrial weed management and forestry, it is desirable to control a broad range of weeds for an extended period of time. The control of large weeds, or taller species such as bushes or trees may also be desirable. Industrial weed management includes for example railway and right-of-way management, fence lines and non-crop land such as industrial and building sites, gravel areas, roads or sidewalks. Forestry includes for example the clearing of existing forest or bushland, the removal of regrowth after mechanical forest cutting, or the management of weeds under forestry plantations. In the latter case, it may be desirable to shield desirable trees from contact with the spray solution that contains the herbicidal mixture according to the present invention

The herbicidal composition can also be used for weed control in turf and lawn provided the desirable grass species are tolerant to herbicidal composition. In particular, such herbicidal compositions can be used in desirable grass that has been rendered tolerant to the respective agrochemical active ingredient, e.g. glufosinate or its salts, by mutagenesis or genetic engineering.

Glufosinate and its salts are non-selective systemic herbicides having a good post-emergence activity against numerous weeds and thus can be used in burndown programs, in industrial vegetation management and forestry, in vegetable and perennial crops and in turf and lawn.

Therefore, the present invention also relates to a method for burndown treatment of undesirable vegetation in crops, comprising applying the herbicidal composition, to a locus where crops will be planted before planting (or seeding) or emergence of the crop. Herein, the herbicidal composition is applied undesirable vegetation or the locus thereof.

The present invention also relates to a method for controlling undesirable vegetation, which method comprises applying the herbicidal composition, to a locus where undesirable vegetation is present or is expected to be present. The application may be done before, during and/or after, preferably during and/or after, the emergence of the undesirable vegetation. In one embodiment, the application is carried out before emergence of the crop, which is cultivated at the locus where the undesirable vegetation is present or is expected to be present. In another embodiment, the application is carried out before planting the crop.

As used herein, the terms “controlling” and “combating” are synonyms.

As used herein, the terms “undesirable vegetation”, “undesirable species”, “undesirable plants”, “harmful plants”, “undesirable weeds”, or “harmful weeds” are synonyms.

The term “locus”, as used herein, means the area in which the vegetation or plants are growing or will grow, typically a field.

In burndown programs, the herbicidal composition(s) can be applied prior to seeding (planting) or after seeding (or planting) of the crop plants but before the emergence of the crop plants, in particular prior to seeding. The herbicidal compositions are preferably applied prior to seeding of the crop plants. For burndown, the herbicidal composition(s) will generally be applied a date up to 9 months, frequently up to 6 months, preferably up to 4 months prior to planting the crop. The burndown application can be done at a date up to 1 day prior to emergence of the crop plant and is preferably done at a date prior to seeding/planting of the crop plant, preferably at a date of at least one day, preferably at least 2 days and in particular at least one 4 days prior to planting or from 6 months to 1 day prior emergence, in particular from 4 months to 2 days prior emergence and more preferably from 4 months to 4 days prior emergence. It is, of course, possible to repeat the burndown application once or more, e.g. once, twice, three times, four times or five times within that time frame.

It is a particular benefit of the herbicidal compositions that they have a very good post-emergence herbicide activity, i.e. they show a good herbicidal activity against emerged undesirable plants. Thus, in a preferred embodiment of invention, the herbicidal compositions are applied post-emergence, i.e. during and/or after, the emergence of the undesirable plants. It is particularly advantageous to apply the herbicidal composition post emergent when the undesirable plant starts with leaf development up to flowering. The herbicidal compositions are particularly useful for controlling undesirable vegetation which has already developed to a state, which is difficult to control with conventional burndown mixtures, i.e. when the individual weed is taller than 10 cm (4 inches) or even taller than 15 cm (6 inches) and/or for heavy weed populations. In the case of a post-emergence treatment of the plants, the herbicidal compositions are preferably applied by foliar application.

The herbicidal compositions can be applied in conventional manner by using techniques as skilled person is familiar with. Suitable techniques include spraying, atomizing, dusting, spreading or watering. The type of application depends on the intended purpose in a well-known manner; in any case, they should ensure the finest possible distribution of the active ingredients according to the invention.

In one embodiment, the herbicidal compositions are applied to locus mainly by spraying, in particular foliar spraying of an aqueous dilution of the active ingredients of the mixture. Application can be carried out by customary spraying techniques using, for example, water as carrier and spray liquor rates of from about 10 to 2000 l/ha or 50 to 1000 l/ha (for example from 100 to 500 l/ha). Application of the inventive mixtures by the low-volume and the ultra-low-volume method is possible, as is their application in the form of microgranules.

The required application rate of the herbicidal composition depends on the density of the undesired vegetation, on the development stage of the plants, on the climatic conditions of the location where the mixture is used and on the application method.

In general, the rate of application of L-glufosinate or its salt is usually from 50 g/ha to 3000 g/ha and preferably in the range from 100 g/ha to 2000 g/ha or from 200 g/ha to 1500 g/ha of active substance (a.i.).

When using the herbicidal composition in the methods of the present invention, the glufosinate or a salt thereof and the compound of formula (I) can be applied simultaneously or in succession, where undesirable vegetation may occur. Herein, it is immaterial whether the individual compounds present in the inventive mixtures are formulated jointly or separately and applied jointly or separately, and, in the case of separate application, in which order the application takes place. It is only necessary, that the individual compounds present in the inventive mixtures are applied in a time frame, which allows simultaneous action of the active ingredients and/or the compound of formula (I) on the undesirable plants.

The herbicidal compositions show a persistent herbicidal activity, even under difficult weathering conditions, which allows a more flexible application in burndown applications and minimizes the risk of weeds escaping. Apart from that, the herbicidal compositions show superior crop compatibility with certain conventional crop plants and with herbicide tolerant crop plants, i.e. their use in these crops leads to a reduced damage of the crop plants and/or does not result in increased damage of the crop plants. Thus, the herbicidal compositions can also be applied after the emergence of the crop plants. The herbicidal compositions may also show an accelerated action on harmful plants, i.e. they may affect damage of the harmful plants more quickly.

The herbicidal compositions are also suitable for controlling weeds that are resistant to commonly used herbicides such as, for example, weeds that are resistant to glyphosate, weeds that are resistant to auxin inhibitor herbicides such as e. g. 2,4-D or dicamba, weeds that are resistant to photosynthesis inhibitors such as e. g. atrazine, weeds that are resistant to ALS inhibitors such as e. g. sulfonylureas, imidazolinones or triazolopyrimidines, weeds that are resistant to ACCase inhibitors such as e. g. clodinafop, clethodim or pinoxaden or weeds that are resistant to protoporphyrinogen-IX-oxidase inhibitors such as e. g. sulfentrazone, flumioxazine, fomesafen or acifluorfen, for example the weeds that are listed in the International Survey of Resistant Weeds (http://www.weedscience.org/Summary/SpeciesbySOATable.aspx). In particular, they are suitable for controlling the resistant weeds that are resistant go glufosinate or its salts, such as listed in the International Survey of Resistant Weeds, for example ACCase resistant Echinochloa crus-galli, Avena fatua, Alopecurus myosuroides, Echinochloa colona, Alopecurus japonicus, Bromus tectorum, Hordeum murinum, lschaemum rugosum, Setaria viridis, Sorghum halepense, Alopecurus aequalis, Apera spica-venti, Avena sterilis, Beckmannia szygachne, Bromus diandrus, Digitaria sanguinalis, Echinocloa oryzoides, Echinochloa phyllopogon, Phalaris minor, Phalaris paradoxa, Setaria faberi, Setaria viridis, Brachypodium distachyon, Bromus diandrus, Bromus sterilis, Cynosurus echinatus, Digitaria insularis, Digitaria ischaemum, Leptochloa chinensis, Phalaris brachystachis, Rotboellia cochinchinensis, Digitaria ciliaris, Ehrharta longiflora, Eriochloa punctata, Leptochloa panicoides, Lolium persicum, Polypogon fugax, Sclerochloa kengiana, Snowdenia polystacha, Sorghum sudanese and Brachiaria plantaginea, ALS inhibitor resistant Echinochloa crus-galli, Poa annua, Avena fatua, Alopecurus myosuroides, Echinochloa colona, Amaranthus hybridus, Amaranthus palmeri, Amaranthus rudis, Conyza sumatrensis, Amaranthus retroflexus, Ambrosia artemisifolia, Conyza canadensis, Kochia scoparia, Raphanus raphanistrum, Senecio vernalis, Alopecurus japonicus, Bidens pilosa, Bromus tectorum, Chenopodium album, Conyza bonariensis, Hordeum murinum, lschaemum rugosum, Senecio vulgaris, Setaria viridis, Sisymbrium orientale, Sorghum halepense, Alopecurus aequalis, Amaranthus blitum, Amaranthus powellii, Apera spica-venti, Avena sterilis, Brassica rapa, Bromus diandrus, Descurainia sophia, Digitaria sanguinalis, Echinochloa oryzoides, Echinochloa phyllopogon, Euphorbia heterophylla, Lactuca serriola, Phalaris minor, Phalaris paradoxa, Setaria faberi, Setaria viridis, Sinapis arvensis, Solanum ptycanthum, Sonchus oleraceus, Stellaria media, Amaranthus blitoides, Amaranthus spinosus, Amaranthus viridis, Ambrosia trifida, Bidens subalternans, Bromus diandrus, Bromus sterilis, Capsella bursapastoris, Centaurea cyanus, Cynosurus echinatus, Cyperus difformis, Fimbristilis miliacea, Galeopsis tetrahit, Galium aparine, Galium spurium, Helianthus annuus, Hirschfeldia incana, Limnocharis flava, Limnophila erecta, Papaver rhoeas, Parthenium hysterophorus, Phalaris brachystachis, Polygonum convolvulus, Polygonum lapathifolium, Polygonum persicaria, Ranunculus acris, Rottboellia cochinchinensis, Sagittaria montevidensis, Salsola tragus, Schoenoplectus mucronatus, Setaria pumila, Sonchus asper, Xanthium strumarium, Ageratum conyzoides, Alisma canaliculatum, Alisma plantago-aquatica, Ammannia auriculata, Ammannia coccinea, Ammannia arvensis, Anthemis cotula, Bacopa rotundifolia, Bifora radians, Blyxa aubertii, Brassica tournefortii, Bromus japonicus, Bromus secalinus, Lithospermum arvense, Camelina microcarpa, Chamaesyce maculata, Chrysanthemum coronarium, Clidemia hirta, Crepis tectorum, Cuscuta pentagona, Cyperus brevifolis, Cyperus compressus, Cyperus esculentus, Cyperus iria, Cyperus odoratus, Damasonium minus, Diplotaxis erucoides, Diplotaxis tenuifolia, Dopatrum junceum, Echium plantagineum, Elatine triandra, Eleocharis acicularis, Erucaria hispanica, Erysimum repandum, Galium tricornutum, Iva xanthifolia, Ixophorus unisetus, Lamium amplexicaule, Limnophilia sessiliflora, Lindernia dubia, Lindernia micrantha, Lindernia procumbens, Ludwigia prostrata, Matricaria recutita, Mesembryanthemum crystallinum, Monochoria korsakowii, Monochoria vaginalis, Myosoton aquaticum, Neslia paniculata, Oryza sativa var. sylvatica, Pentzia suffruticosa, Picris hieracioides, Raphanus sativus, Rapistrum rugosum, Rorippa indica, Rotala indica, Rotala pusilla, Rumex dentatus, Sagittaria guayensis, Sagittaria pygmaea, Sagittaria trifolia, Schoenoplectus fluviatilis, Schoenoplectus juncoides, Schoenoplectus wallichii, Sida spinosa, Silene gallica, Sinapis alba, Sisymbrium thellungii, Sorghum bicolor, Spergula arvensis, Thlaspi arvense, Tripleurospermum perforatum, Vaccaria hispanica and Vicia sativa, photosynthesis inhibitor resistant Echinochloa crus-galli, Poa annua, Alopecurus myosuroides, Echinochloa colona, Amaranthus hybridus, Amaranthus palmeri, Amaranthus rudis, Conyza sumatrensis, Amaranthus retroflexus, Ambrosia artemisifolia, Conyza canadensis, Kochia scoparia, Raphanus raphanistrum, Senecio vernalis, Alopecurus japonicus, Bidens pilosa, Bromus tectorum, Chenopodium album, Conyza bonariensis, lschaemum rugosum, Senecio vulgaris, Setaria viridis, Sisymbrium orientale, Amaranthus blitum, Amaranthus powellii, Apera spica-venti, Beckmannia syzigachne, Brassica rapa, Digitaria sanguinalis, Euphorbia heterophylla, Phalaris minor, Phalaris paradoxa, Setaria faberi, Setaria viridis, Sinapis arvensis, Solanum ptycanthum, Stellaria media, Amaranthus blitoides, Amaranthus viridis, Bidens subalternans, Brachypodium distachyon, Capsella bursa-pastoris, Chloris barbata, Cyperus difformis, Echinochloa erecta, Epilobium ciliatum, Polygonum aviculare, Polygonum convolvulus, Polygonum lapathifolium, Polygonum persicaria, Portulaca oleracea, Schoenoplectus mucronatus, Setaria pumila, Solanum nigrum, Sonchus asper, Urochloa panicoides, Vulpia bromoides, Abutilon theophrasti, Amaranthus albus, Amaranthus cruentus, Arabidopsis thaliana, Arenaria serpyllifolia, Bidens tripartita, Chenopodium album, Chenopodium ficifolium, Chenopodium polyspermum, Crypsis schoenoides, Datura stramonium, Epilobium tetragonum, Galinsoga ciliata, Matricaria discoidea, Panicum capillare, Panicum dichotomiflorum, Plantago lagopus, Polygonum hydopiper, Polygonum pensylvanicum, Polygonum monspeliensis, Rostraria, smyrnacea, Rumex acetosella, Setaria verticillata and Urtica urens, PS-I-electron diversion inhibitor resistant Poa annua, Conyza sumatrensis, Conyza canadensis, Alopecurus japonicus, Bidens pilosa, Conyza bonariensis, Hordeum murinum, Ischaemum rugosum, Amaranthus blitum, Solanum ptycanthum, Arctotheca calendula, Epilobium ciliatum, Hedyotis verticillata, Solanum nigrum, Vulpia bromoides, Convolvulus arvensis, Crassocephalum crepidioides, Cuphea carthagensis, Erigeron philadelphicus, Gamochaeta pensylvanica, Landoltia punctata, Lepidium virginicum, Mazus fauriei, Mazus pumilus, Mitracarpus hirtus, Sclerochloa dura, Solanum americanum and Youngia japonica, glyphosate resistant Poa annua, Echinochloa colona, Amaranthus hybridus, Amaranthus palmeri, Amaranthus rudis, Conyza sumatrensis, Ambrosia artemisifolia, Conyza canadensis, Kochia scoparia, Raphanus raphanistrum, Bidens pilosa, Conyza bonariensis, Hordeum murinum, Sorghum halepense, Brassica rapa, Bromus diandrus, Lactuca serriola, Sonchus oleraceus, Amaranthus spinosus, Ambrosia trifida, Digitaria insularis, Hedyotis verticillata, Helianthus annuus, Parthenium hysterophorus, Plantago lanceolata, Salsola tragus, Urochloa panicoides, Brachiaria eruciformis, Bromus rubens, Chloris elata, Chloris truncats, Chloris virgata, Cynodon hirsutus, Lactuca saligna, Leptochloa virgata, Paspalum paniculatum and Tridax procumbens, microtubule assembly inhibitor resistant Echinochloa crus-galli, Poa annua, Avena fatua, Alopecurus myosuroides, Amaranthus palmeri, Setaria viridis, Sorghum halepense, Alopecurus aequalis, Beckmannia syzigachne and Fumaria densifloria, auxin herbicide resistant Echinochloa crus-galli, Echinochloa colona, Amaranthus hybridus, Amaranthus rudis, Conyza sumatrensis, Kochia scoparia, Raphanus raphanistrum, Chenopodim album, Sisymbrium orientale, Descurainia sophia, Lactuca serriola, Sinapis arvensis, Sonchus oleraceus, Stellaria media, Arctotheca calendula, Centaurea cyanus, Digitaria ischaemum, Fimbristylis miliacea, Galeopsis tetrahit, Galium aparine, Galium spurium, Hirschfeldia incana, Limnocharis flava, Limnocharis erecta, Papaver rhoeas, Plantago lanceolata, Ranunculus acris, Carduus nutans, Carduus pycnocephalus, Centaurea soltitialis, Centaurea stoebe ssp. Micranthos, Cirsium arvense, Commelina diffusa, Echinochloa crus-pavonis, Soliva sessilis and Sphenoclea zeylanica, HPPD inhibitor resistant Amaranthus palmeri and Amaranthus rudis, PPO inhibitor resistant Acalypha australis, Amaranthus hybridus, Amaranthus palmeri, Amaranthus retroflexus, Amaranthus rudis, Ambrosia artemisifolia, Avena fatua, Conyza sumatrensis, Descurainia sophia, Euphorbia heterophylla and Senecio vernalis, carotenoid biosynthesis inhibitor resistant Hydrilla verticillata, Raphanus raphanistrum, Senecio vernalis and Sisymbrium orientale, VLCFA inhibitor resistant Alopecurus myosuroides, Avena fatua and Echinochloa crusgalli.

The herbicidal compositions are suitable for combating/controlling common harmful plants in fields, where useful plants shall be planted (i.e. in crops). The inventive mixtures are generally suitable, such as for burndown of undesired vegetation, in fields of the following crops:

Grain crops, including e.g. cereals (small grain crops) such as wheat (Triticum aestivum) and wheat like crops such as durum (T. durum), einkorn (T. monococcum), emmer (T. dicoccon) and spelt (T. spelta), rye (Secale cereale), triticale (Tritiosecale), barley (Hordeum vulgare); maize (corn; Zea mays); sorghum (e.g. Sorghum bicolour); rice (Oryza spp. such as Oryza sativa and Oryza glaberrima); and sugar cane;

Legumes (Fabaceae), including e.g. soybeans (Glycine max.), peanuts (Arachis hypogaea and pulse crops such as peas including Pisum sativum, pigeon pea and cowpea, beans including broad beans (Vicia faba), Vigna spp., and Phaseolus spp. and lentils (lens culinaris var.); brassicaceae, including e.g. canola (Brassica napus), oilseed rape (OSR, Brassica napus), cabbage (B. oleracea var.), mustard such as B. juncea, B. campestris, B. narinosa, B. nigra and B. tournefortii; and turnip (Brassica rapa var.);
other broadleaf crops including e.g. sunflower, cotton, flax, linseed, sugarbeet, potato and tomato;
   TNV-crops (TNV: trees, nuts and vine) including e.g. grapes, citrus, pomefruit, e.g. apple and pear, coffee, pistachio and oilpalm, stonefruit, e.g. peach, almond, walnut, olive, cherry, plum and apricot;
   turf, pasture and rangeland;
onion and garlic;
   bulb ornamentals such as tulips and narcissus;
conifers and deciduous trees such as pinus, fir, oak, maple, dogwood, hawthorne, crabapple, and rhamnus (buckthorn); and
garden ornamentals such as roses, petunia, marigold and snapdragon.

In one embodiment, the method for controlling undesired vegetation is applied in cultivated rice, maize, pulse crops, cotton, canola, small grain cereals, soybeans, peanut, sugarcane, sunflower, plantation crops, tree crops, nuts or grapes. In another embodiment, the method is applied in cultivated crops selected from glufosinate-tolerant crops.

The herbicidal are in particular suitable for burndown of undesired vegetation in fields of the following crop plants: small grain crops such as wheat, barley, rye, triticale and durum, rice, maize (corn), sugarcane, sorghum, soybean, pulse crops such as pea, bean and lentils, peanut, sunflower, sugarbeet, potato, cotton, brassica crops, such as oilseed rape, canola, mustard, cabbage and turnip, turf, pasture, rangeland, grapes, pomefruit, such as apple and pear, stonefruit, such as peach, almond, walnut, pecans, olive, cherry, plum and apricot, citrus, coffee, pistachio, garden ornamentals, such as roses, petunia, marigold, snap dragon, bulb ornamentals such as tulips and narcissus, conifers and deciduous trees such as pinus, fir, oak, maple, dogwood, hawthorne, crabapple and rhamnus.

The herbicidal compositions are most suitable for burndown of undesired vegetation in fields of the following crop plants: small grain crops such as wheat, barley, rye, triticale and durum, rice, maize, sugarcane, soybean, pulse crops such as pea, bean and lentils, peanut, sunflower, cotton, brassica crops, such as oilseed rape, canola, turf, pasture, rangeland, grapes, stonefruit, such as peach, almond, walnut, pecans, olive, cherry, plum and apricot, citrus and pistachio.

### EXAMPLES

The following tables show examples illustrating the invention.

The liquid herbicidal formulations according to the present invention were prepared by providing a solvent B.1 selected from a monohydric alcohol (or a mixture thereof), by providing a solvent B.2 selected from a polyhydric alcohol (or a mixture thereof), combining the two solvent components B.1 and B.2 to a mixture, and then further combining obtained mixture of the solvents with the herbicidal compound A.

The mixture of the herbicide A with the solvents B.1 and B.2 were further mixed with the remaining components as listed in the respective columns in tables M.1 and M.2 showing the compositions according to the present invention.

The stability of the individual formulation examples was evaluated after their preparation from their visual appearance. Stable composition examples according to the present invention appeared here as a single phase and clear transparent solution.

For the further evaluation of their stability, one batch comprising 50 ml samples was stored at about 2° C. for two weeks, and another separate batch comprising 50 ml samples as well were in parallel stored at -10° C. for two weeks.

The compositions that remained clear solutions at about 2° C. were confirmed as stable formulations.

The formulations which were stored at about −10° C. in a freezer for two weeks, and then taken out, were subsequently kept at room temperature for 6 hours in order to thaw without applying any agitation. During storage at temperatures of about 2° C. or below, the aqueous compositions could become partially or completely turbid or opaque. However, if the aqueous compositions appeared within 6 hours again as a transparent, here clear, solution without the need of applying any agitation, the formulation showed evidence for its stability and was evaluated suitable for being applied in agricultural methods.

### I. Components of the Liquid Herbicidal Composition Compositions

TABLE C
Ingredients of the liquid herbicidal composition
according to the present invention:

| | | Product (commercially |
|---|---|---|
| | | available or individually |
| | | formulated for |
| Components | Chemical | composition examples) |
| A. Herbicides | | |
| | Glufosinate-Ammonium | Active ingredient |
| B. Solvents | | |
| | Solvent B.1 | |
| | (Monohydric alcohols) | |
| B.1a | Methanol | |
| B.1b | Ethanol | |
| B.1c | Isopropanol (Propanol-2) | |
| | Solvent B.2 | |
| | (Polyhydric alcohols) | |
| B.2a | 1,2-propylene glycol | |
| B.2b | Glycerol | |

Tables M.1 and M.2 show nine liquid herbicidal compositions according to the present invention, and table MC.1 show nine comparative herbicidal compositions, which do not comprise the mixture of the monohydric and polyhydric alcohols according to the present invention.

The final compositions were prepared by mixing the ingredients at the concentrations as provided in the respective tables.

### I.1 Examples of Liquid Herbicidal Composition Compositions According to the Invention

All experiments in this section showed, that it is possible to obtain stable formulations containing a higher amount of the active ingredient glufosinate ammonium, if a solvent mixture of monohydric alcohols and polyhydric alcohols is used.

The inventive composition examples 1 to 4 in table M.1 were prepared by using a mixture of solvent B.1 being ethanol and of solvent B.2 being monopropylene glycol at different ratios. All composition examples appeared as a clear solution at 2° C. They also reappeared as clear solutions after being thaw to room temperature after storage at −10° C. for 2 weeks.

The inventive composition examples 8 and 9 in table M.2 were prepared was prepared accordingly by using monopropylene glycol and ethanol, but both remained as a clear single phase solution even at −10° C.

The inventive composition examples 5 to 7 in table M.2 were prepared by alternating the solvent components B.1 and B.2. Inventive composition 5 was prepared by using a mixture glycerol as solvent B.1 and ethanol as solvent B.2, whereas inventive composition examples 6 and 7 were prepared by combing solvent B.1 monopropylene glycol with either isopropanol (example 6) or methanol (example 7). All three composition examples 5, 6 and 7 were proven not only to be a stable formulation at room temperature, but remained as well as clear single phase solutions even at −10° C.

Thereby evidence is given, that when in compositions comprising the herbicide A, B1 type monohydric alcoholic solvents are combined with B2 type polyhydric alcoholic solvents, stable liquid compositions are obtained (Examples 1-9).

TABLE M.1

| Ingredient ¹⁾ | Example 1 | Example 2 | Example 3 | Example 4 |
|---|---|---|---|---|
| Glufosinate-Ammonium | 28.94% | 17.43% | 17.43% | 17.43% |
| *MEA-LES | 28.21% | 45.80% | 45.80% | 45.80% |
| Dipropylene glycol | 7.96% | 12.92% | 12.92% | 12.92% |
| 1,2-propylene glycol | 7.66% | 1.10% | 2.29% | 3.49% |
| Ethanol | 8.17% | 5.32% | 4.13% | 2.94% |
| Water | 19.06% | 17.43% | 17.43% | 17.43% |
| Total | 100.00% | 100.00% | 100.00% | 100.00% |
| visual appearance | Clear solution | Clear solution | Clear solution | Clear solution |
| 2 week at 2° C. | Clear solution | Clear solution | Clear solution | Clear solution |
| 2 weeks at 2° C. | Clear solution | Clear solution | Clear solution | Clear solution |
| then 6 hours at room | | | | |
| temperature | | | | |
| 2 weeks at −10 C. | 100% Frozen | 100% Frozen | 100% Frozen | 100% Frozen |
| 2 weeks at −10 C. | Clear solution | Clear solution | Clear solution | Clear solution |
| then 6 hours at room | | | | |
| temperature | | | | |

*R—O—(CH₂CH₂O)ₓ—SO₃ NH₃CH₂CH₂OH
R = Liner, saturated C₁₀ C₁₆ fatty alcohol
X = approx.
Molecular weight: ~418 g/mole
¹⁾ All amounts are given in % by weight

TABLE M.2

| Ingredient ¹⁾ | Example 5 | Example 6 | Example 7 | Example 8 | Example 9 |
|---|---|---|---|---|---|
| Glufosinate-Ammonium | 17.43% | 17.43% | 17.43% | 16.57% | 13.77% |
| *MEA-LES | 45.80% | 45.80% | 45.80% | 46.04% | 49.42% |
| Dipropylene glycol | 12.92% | 12.92% | 12.92% | 12.99% | 13.94% |
| Glycerol | 3.49% | | | | |
| 1,2-propylene glycol | | 2.29% | 2.29% | 2.05% | 4.50% |
| Ethanol | 2.94% | | | 5.32% | 2.75% |
| Methanol | | | 4.13% | | |
| Isopropanol | | 4.13% | | | |
| Water | 17.43% | 17.43% | 17.43% | 17.03% | 16.00% |
| Total | 100.01% | 100.00% | 100.00% | 100.00% | 100.00% |
| visual appearance | Clear solution | Clear solution | Clear solution | Clear solution | Clear solution |
| 2 week at 2° C. | Clear solution | Clear solution | Clear solution | Clear solution | Clear solution |
| 2 weeks at 2° C. | Clear solution | Clear solution | Clear solution | Clear solution | Clear solution |
| then 6 hours at room | | | | | |
| temperature | | | | | |

*R—O—(CH₂CH₂O)ₓ—SO₃ NH₃CH₂CH₂OH
R = Liner, saturated C₁₀ C₁₆ fatty alcohol
X = approx.
Molecular weight: ~418 g/mole
¹⁾ All amounts are given in % by weight

1.2 Comparative Examples of Liquid Herbicidal Composition Compositions (Not Falling under the Invention)

All comparative experiments in this section showed, that it is not possible to obtain stable formulations containing a higher amount of the active ingredient glufosinate ammonium, when no solvent mixture of monohydric alcohols and polyhydric alcohols according to the present invention is used, or when only one solvent selected from monohydric alcohols and polyhydric alcohols is used.

The comparative composition example 1 was prepared by using only ethanol compared to the inventive composition example 1 instead of the mixture of monopropylene glycol and ethanol. In alteration thereto, comparative composition examples 2 and 3 were prepared by using only monopropylene glycol in different concentrations compared to the inventive composition example 1 instead of the mixture of monopropylene glycol and ethanol.

And finally, comparative composition example 4 was prepared by omitting both solvents, the monopropylene glycol and the ethanol, respectively “replacing” them simply with water compared to inventive composition example 1.

None of the comparative composition examples 1 to 4 resulted in a homogenous solution as the inventive example.

Similar to comparative composition example 1, comparative composition example 5 was prepared by using only ethanol compared to the inventive composition example 1 instead of the mixture of monopropylene glycol and ethanol. Although, comparative composition 5 resulted at first in a clear solution at room temperature, it irreversibly phase-separated after storage at 2° C. for 2 weeks.

Same could be observed for comparative composition example 8, which was prepared by using only ethanol compared to the inventive composition example 8 instead of the mixture of monopropylene glycol and ethanol. Also here—although, comparative composition 8 resulted at first in a clear solution at room temperature, it irreversibly phase-separated after storage at 2° C. for 2 weeks

In comparative composition examples 6 and 7, methanol (comparative example 6) and isopropanol (comparative example 7) were used instead of the mixture of ethanol and monopropylene glycol compared to inventive composition examples 2 and 3. Both comparative composition examples did not form single phase solutions even at room temperature.

Finally, comparative composition example 9 was prepared by omitting both solvents, the monopropylene glycol and the ethanol, respectively “replacing” them simply with water compared to inventive composition example 8.

By comparison evidence is given, that when in compositions comprising the herbicide A, it is essentially required that two types of solvents need to be present, (B.1) monohydric alcoholic solvents combined with (B.2) polyhydric alcoholic solvents, in order to obtain stable liquid herbicidal compositions.

TABLE MC.1
Comparative Examples

| Ingredient ¹⁾ | C. Ex. 1 | C. Ex. 2 | C. Ex. 3 | C. Ex. 4 | C. Ex. 5 | C. Ex. 6 | C. Ex. 7 | C. Ex. 8 | C. Ex. 9 |
|---|---|---|---|---|---|---|---|---|---|
| Glufosinate- | 28.94% | 28.94% | 28.94% | 28.94% | 17.43% | 17.43% | 17.43% | 16.57% | 16.07% |
| Ammonium | | | | | | | | | |
| *MEA-LES | 28.21% | 28.21% | 28.21% | 28.21% | 45.80% | 45.80% | 45.80% | 46.04% | 48.75% |
| Dipropylene glycol | 7.96% | 7.96% | 7.96% | 7.96% | 12.92% | 12.92% | 12.92% | 12.99% | 13.75% |
| Propylene glycol | | | 8.17% | | | | | | |
| monomethyl ether | | | | | | | | | |
| 1,2-propylene glycol | | 15.83% | 7.66% | | | | | | |
| Ethanol | 15.83% | | | | 6.42% | | | 7.37% | |
| Methanol | | | | | | 6.42% | | | |
| Isopropanol | | | | | | | 6.42% | | |
| Water | 19.06% | 19.06% | 19.06% | 34.89% | 17.43% | 17.43% | 17.43% | 17.03% | 21.43% |
| Total | 100.00% | 100.00% | 100.00% | 100.00% | 100.00% | 100.00% | 106.42% | 100.00% | 100.00% |
| visual appearance | 2 phase | 2 phase | Inhomo- | 2 phase | Clear | 2 phase | 2 phase | Clear | 2 phase |
| | Precip- | Precip- | geneous | Precip- | solution | | | solution | |
| | itates | itates | Gel | itates | | | | | |
| 2 week at 2° C. | N/A | N/A | N/A | N/A | 2 phase | N/A | N/A | 2 phase | N/A |
| 2 weeks at 2° C. | N/A | N/A | N/A | N/A | N/A | N/A | N/A | N/A | N/A |
| then 6 hours at room | | | | | | | | | |
| temperature | | | | | | | | | |
| 2 weeks at −10 C. | N/A | N/A | N/A | N/A | N/A | N/A | N/A | N/A | N/A |
| 2 weeks at −10 C. | N/A | N/A | N/A | N/A | N/A | N/A | N/A | N/A | N/A |
| then 6 hours at room | | | | | | | | | |
| temperature | | | | | | | | | |

¹⁾ All amounts are given in % by weight

1. An aqueous liquid herbicidal composition comprising
(B) 5 to 45 weight %, based on the total weight of the composition, of one herbicidal compound selected from glufosinate, a salt thereof, preferably the ammonium salt, and/or its respective (L-)isomers
(B) a mixture of at least two alcoholic solvents, comprising a monohydric alcohol (B.1) and a polyhydric solvent (B.2), wherein
(B.1) the monohydric alcohol B.1 is selected from methanol, ethanol and isopropanol, and any mixture thereof;
and
(B.2) the polyhydric alcohol B.2 is selected from 1,2-propylene glycol and glycerol, and a mixture thereof;
(C) water
and
(D) 15 to 70 weight %, based on the total weight of the composition, of at least one compound of formula (I)
[R-(A)ₓ-OSO₃⁻]-M⁺ (I);
wherein
R is C₁₀-C₁₆-alkyl, C₁₀-C₁₆-alkenyl, or C₁₀-C₁₆-alkynyl;
A is a group 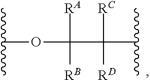
wherein
R^{A}, R^{B}, R^{C}, and R^{D} are selected from H, CH₃, or CH₂CH₃ with the proviso that the sum of C-atoms of R^{A}, R^{B}, R^{C}, and R^{D} is 0, 1 or 2;
M⁺ is a monovalent cation selected from the group of alkali metal ions, NH₄⁺ and an ammonium cation of a primary, secondary or tertiary amine or a quaternary ammonium cation, or a mixture thereof; and
x is a number selected from 0 to 10.

2. The liquid herbicidal composition according to claim 1, wherein the composition comprises 1 to 20 weight %, preferably 2 to 15 weight % or more preferably 2 to 10 weight % of solvent B.1.

3. The liquid herbicidal composition according to claim 1 or 2, wherein
the composition comprises 1 to 30 weight %, preferably 2 to 20 weight % or more preferably 2 to 15 weight % of solvent B.2.

4. The liquid herbicidal composition according to claim 1, 2 or 3, wherein
the composition comprises 10 to 40 weight % of the herbicidal compound (A).

5. The liquid herbicidal composition according to any of the preceding claims, wherein the solvent B.1 is ethanol.

6. The liquid herbicidal composition according to any of the preceding claims, wherein the solvent B.2 is propylene glycol.

7. The liquid herbicidal composition according to claim 1 comprising
A) 10 to 40 weight % of the herbicidal compound selected from glufosinate, a salt thereof, preferably the ammonium salt, and/or its respective (L-)isomers;
B.1) 2 to 15 weight % of ethanol;
B.2) 2 to 20 weight% of 1,2-propylene glycol and
C) at least 7 weight % water.

8. The liquid herbicidal composition according to claims 1 comprising
A) 13 to 36% weight % of the herbicidal compound selected from glufosinate, a salt thereof, preferably the ammonium salt, and/or its respective (L-)isomers;
B.1) 2 to 10 weight % of ethanol;
B.2) 2 to 15 weight % of 1,2-propylene glycol; and
C) at least 8 weight % of water.

9. The liquid herbicidal composition according to any of the preceding claims, wherein the index x in formula (I) is a number from 1 to 10.

10. The liquid herbicidal composition according to any one of the preceding claims, wherein the index x in compound of formula (I) is from 1 to 3.

11. The liquid herbicidal composition according to any one of the preceding claims, wherein in formula (I) R^{A}, R^{B}, R^{C}, and R^{D} are each H.

12. The liquid herbicidal composition according to any one of the preceding claims, wherein the cation M⁺ is an ammonium cation of a primary, secondary, or tertiary amine, or a quaternary ammonium cation, where M⁺ contains exactly one nitrogen atom per molecule.

13. The liquid herbicidal composition according to any one of the preceding claims, wherein the cation M⁺ is of formula (II) 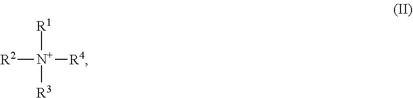
wherein
R¹, R², R³ and R⁴ are H or C₁-C₁₀-alkyl, which is unsubstituted or substituted with OH, C₁-C₁₀-alkoxy, or hydroxy-C₁-C₁₀-alkoxy; or two of the substituents R¹, R², R³, and R⁴ form, together with the N-atom to which they are bound, a 5-, or 6-membered, saturated, partially- or fully unsaturated heterocycle containing optionally and additionally one or two oxygen or sulfur atoms, wherein said sulfur atom(s) are independently from one another oxidized or non-oxidized.

14. The liquid herbicidal composition according to any one of the preceding claims, wherein the cation M⁺ is a protonated amine selected from ethanolamine, diethanolamine, diglycolamine, 1-aminopropan-2-ol, 2-dimethylaminoethanol, 2-(butylamino)ethanol, 2-diethylaminoethanol, 2-(tert-butylamino)ethanol, N-(tert-butyl)diethanolamine, triethanolamine, 2-ethylaminoethanol, 2-aminoheptan, triisopropylamine, N-(2-hydroxyethyl)morpholin, N-methylmorpholine, N-butyldiethanolamin or 2-(dibutylamino)ethanol, or any mixture thereof.

15. The liquid herbicidal composition according to claim 14, wherein
the cation M⁺ is a protonated amine selected from ethanolamine, diethanolamine, diglycolamine, 1-aminopropan-2-ol, 2-dimethylaminoethanol or triethanolamine, or any mixture thereof.

16. The liquid herbicidal composition according to any one of claims 1 to 11, wherein the cation M⁺ is sodium.

17. The liquid herbicidal composition according to any one of the preceding claims, wherein composition comprises
A) 13 to 36 weight % the herbicidal compound selected from glufosinate, a salt thereof, preferably the ammonium salt, and/or its respective (L-)isomers;
B.1) 2 to 10 weight % of ethanol;
B.2) 2 to 15 weight % of 1,2-propylene glycol;
C) 8 to 36 weight % water; and
D) 15 to 70 weight % of a compound of formula (I).

18. The liquid herbicidal composition according to claim 17, wherein composition further comprises
E) up to 20 weight % of other ingredients selected from further solvents, pigments, anti-foaming agents, anionic, nonionic, cationic or zwitterionic surfactants as thickeners.

19. Method for producing an aqueous liquid herbicidal composition comprising the steps of
(a) providing a solvent B.1 as defined in claim 1,
(b) providing a solvent B.2 as defined in claim 1,
(c) combining the two solvent components B.1 and B.2 to a mixture,
(d) combining the obtained mixture of the solvent components with water, the herbicidal compound A and the compound of the formula (I) such that a composition as defined in any one of claims 1 to 16 is obtained.

20. Method for controlling undesired plant growth and/or controlling harmful plants, comprising the step of applying the liquid herbicidal composition as defined in any of claims 1 to 18 onto the undesired plants or the harmful plants, on parts of the undesired plants or the harmful plants, or on the area where the undesired plants or the harmful plants grow.

21. Use of the liquid herbicidal composition as defined in any of claims 1 to 18 in the field of agriculture.
